(19) United States
(12) Patent Application Publication
(10) Pub. No.: US 2012/0265559 A1
(43) Pub. Date: Oct. 18, 2012

(54) System and Method for Integrating Project Delivery Risk Management

(76) Inventor: Joseph A. Colagiovanni, JR., St. Louis, MO (US)

(21) Appl. No.: 13/445,875

(22) Filed: Apr. 12, 2012

Related U.S. Application Data
(60) Provisional application No. 61/474,637, filed on Apr. 12, 2011.

(51) Int. Cl. G06Q 40/08

(52) U.S. Cl. 705/4

(57) ABSTRACT

A system and method for managing risk on a project may include storing project information that reflects contract risk allocation provisions and project contingencies. The project may further be insured by a coordinated set of insurance policies. The project information may further include project definitions and terms of the insurance policies. A project participant may be enabled to submit a claim for coverage under the project contingencies or insurance policies that is related to at least one project definition. At least one other project participant may be enabled to submit a response to the submitted claim. Access to the submitted claim and to at least one submitted response to may be provided to a project manager. The project manager may be enabled to submit a decision about the submitted claim. The project participants may be notified of the decision about the submitted claim by the project manager.

### BACKGROUND OF THE INVENTION

This application claims priority to co-pending U.S. Provisional Patent Application Ser. No. 61/474,637 entitled “SYSTEM AND METHOD FOR INTEGRATING PROJECT DELIVERY RISK MANAGEMENT AND INSURANCE PROGRAM,” filed on Apr. 12, 2011 the contents of which are hereby incorporated by reference in their entirety.

### BACKGROUND OF THE INVENTION

Significant projects, such as complex construction, typically use multiple contractors and subcontractors (“contractors”) to develop, design and implement the project. As a result of the magnitude of these projects and issues involved, financial risk can be significant to the project developer and the various contractors before, during, and after development of the project. Consider, for example, an oil rig platform that costs upwards of $750 million for design, development, construction, and deployment. In the event that the platform has a catastrophic failure, resulting litigation due to design flaws, environmental damage, construction deficiencies and other causes can be extensive, especially for the ultimate party or parties that are found to be liable.

Because of these potential liabilities, each of the contractors and subcontractors (as well as the project owner/developer) have traditionally been required to have insurance (or surety bonds) covering certain of their exposures for their respective roles in participating in the project. That is, the norm has been for each participant to have their own insurance/surety policies to engage in significant projects. The consequences of this norm are that each participant (and their respective insurance and surety carriers) becomes inevitably adversarial to the others in order to protect and defend against contractual and insurance liabilities, and that each participant has an inherent incentive and legal obligation to mitigate their own fault while blaming others for failures should a problem occur during any phase of the project development or post project utilization. As a result, a less than “team” atmosphere results among the participants, which, among other things, produces less cooperation in the planning and implementation phases than is often needed to ensure an efficient, cost-effective, timely, safe and quality project. Less cooperation frequently means that the participants will not share documents and information and will not fully coordinate and cooperate with the others if doing so will expose liabilities or weaknesses. Rather, the participants are more likely to “point the finger” at the others in order to avoid liability and assign responsibility accordingly.

While certain “aggregated” insurance products have been developed to address these problems (specifically owner controlled insurance policies {OCIP} and contractor controlled insurance policies {CCIP}), these products still do not cover all risks (design errors and omissions, for example are not covered and off-site activities are excluded). The result is that the participants are still adverse to one another. For example, in the event of a roof leak, the commercial general liability insurance under an OCIP or CCIP will cover only the consequential leak damage if it was caused by the negligence of a covered contractor, but it will not cover the actual roof replacement (which may be covered under a performance bond if the contractor refuses to correct it) and does not cover design errors or omissions that may have contributed to the roof leak. As a result, the roof designer, the builder of the roof, and the owner are all adverse to each other, each attempting to prove their respective “innocence” and the other's “guilt”—typically resulting in costly litigation.

Moreover, insurance providers and sureties underwrite their insurance policies to project participants based on their respective claims histories and management/financial attributes. While there are merits to this model, it largely ignores the specific and unique risks associated with individual projects and does not address or solve the problem of project participants being adversarial and self-interested before, during, and after the project development.

### SUMMARY

The principles of the present invention essentially assure a team atmosphere amongst multiple project participants for a project development by; (i) having a contract that contractually limits (and, beyond the limits, waives) claims among the project participants of the project, (ii) appointing a project manager and appeals decider with contractually binding authority to timely resolve disputes and settle claims within a set time period, and (iii) covering project claims, subject to the contract limits, through a combination of contractually established contingencies and project specific insurance policies that are specially tailored to the contract structure and claims limits for the project and the particular risks associated with the project's development and implementation of the project. The result is improved teamwork among the contractors, the project developer, and the other project participants.

Documents and information that have historically been concealed to minimize risk exposure may now be shared amongst project participants without fear of litigation between or amongst them. The added cooperation between the participants results in a safer, more successful project, with less likelihood of cost overruns and schedule delays. In addition, having a contract in which project participants expressly limit and waive claims against one another, including claims relating to design errors and omissions, construction damage/negligence, etc., reduces the exposure for insurance carriers because the limits for recovery are expressly tied to the specific project and the risk assessments (and related contingencies and insurance coverage established to address those risks). As a result, the insurance carriers are able to actively participate in the planning, design, and risk management of the project (through the project manager). In addition, because the insurance policies are tailored to each project and the related risks and contingencies, more realistic premiums can be charged and the participants can more effectively appraise the value of increased coverage in relation to the associated premium cost. Finally, litigation over fault and related subrogation disputes may be reduced or eliminated as the major, if not all, participants are covered under the same umbrella pursuant to the contract terms and the contingencies and insurance policies established under the principles of the present invention.

The principles of the present invention also contemplates that, because the project participants are contractually bound to one another and a coordinated set of project specific insurance policies may be established, the insurance carrier(s) providing the coverage for the project may reduce risk by offering a percentage participation in the premium and risk associated with one or more policies to other carriers. For example, a lead insurance carrier may agree to provide the design errors and omissions insurance (E&O) for a project, but desire to hold only 40% of the E&O risk. The lead carrier may then offer the other 60% of the E&O policy to one or more other carriers in exchange for an agreed percentage of the premium paid by the project participants for the E&O policy. In one embodiment, the offered percentage of the E&O policy may be offered in an auction, where bidding carriers bid desired premium amounts to accept a percentage of the risk covered by a particular insurance policy for the project.

In addition to insurance policies, the principles of the present invention provide for contractual contingencies from which the project manager may draw to pay claims for occurrences (e.g., delay in construction, faulty design, etc.) that occur before, during, or after development of the project. The contractual contingencies may be categorized in the same manner as the insurance policies so that the project manager may pay the claims from a contractual contingency prior to drawing upon the corresponding insurance policy.

One embodiment for implementing the principles of the present invention includes using a computing system for managing preplanning and development processes of a project both on a contractual and financial basis. The computing system may be used to track adherence to contract terms and risk allocations (including limitations and waivers of claims), insurance policy provisions and payment status by policy participants. In addition one or more computing systems executing a software system may be utilized to allow for document sharing among the participants in connection with their respective roles on the project. In one embodiment, the document sharing operates via a multi-party, interactive website.

A process for integrating project delivery risk management for development of a project may include providing an insurance policy to multiple contractors involved in developing a project, with the insurance policy conforming to contract terms that limit and waive claims among the project participants. Premium payments may be collected from the participants. The premium payments may be tracked. In the event of a legal claim against one or more of the participants related to the project, the claims may be tracked and allocated in accordance with the contract and policy terms and limits. A document exchange system may be provided that enables the participants to exchange documents without concerns about whether those documents may be used later for liability purposes or otherwise affect later claims resolution because claims limits and waivers have been contractually established and the contract contingencies and insurance policies cover primary or all project participants based on the contract terms, not individual fault.

One embodiment of a method for managing risk on a project may include storing, by a computing system, project information that defines scope, schedule, and contractual obligations for a project being covered, so as to reflect contract risk allocation provisions and project contingencies as specified in contract provisions for the project. The project may further be insured by a coordinated set of insurance policies. The project information may further include project definitions and terms of the insurance policies. A project participant may be enabled to submit a claim to the computing system for coverage under the project contingencies or insurance policies that is related to at least one project definition. At least one other project participant may be enabled to submit a response to the submitted claim to the computing system. Access to the submitted claim and to at least one submitted response may be provided to a project manager. The project manager may be enabled to submit a decision to the computing system about the submitted claim. The project participants may be notified of the decision about the submitted claim by the project manager.

One embodiment of a system for managing risk on a project may include a storage unit configured to store project information that defines scope, schedule, and contractual obligations for a project being covered, so as to reflect contract risk allocation provisions and project contingencies as specified in contract provisions for the project. The project may further be insured by a coordinated set of insurance policies. The project information further including project definitions and terms of the insurance policies. A processing unit may be in communication with said storage unit, and be configured to enable a project participant to submit a claim to the computing system for coverage under the project contingencies or insurance policies that is related to at least one project definition. The processing unit may further enable at least one other project participant to submit a response to the submitted claim. Access to the submitted claim and to at least one submitted response may be provided by the processing unit to a project manager. The project manager may be enabled by the processing unit to submit a decision about the submitted claim. The project participants may be notified by the processing unit of the decision about the submitted claim by the project manager.

One embodiment of a method for allocating risk of an insurance policy being issued by a lead insurance carrier for a project may include collecting project information associated with the project being covered by the insurance policy of the lead insurance carrier. The project information may include project provisions, contract contingencies, and insurance terms. The project information may be stored. Another potential carrier may be offered a percentage of the premium and coverage risk associated with the insurance policy. The project information may be made accessible for viewing on an electronic device to the potential other carrier to consider in connection with taking a percentage of the insurance policy. Information associated with the potential other carrier may be stored in association with the project information in response to the lead insurance carrier accepting an offer by the potential other carrier for a percentage of the insurance policy. The percentage of the insurance policy risk and premium may be communicated to the other carrier.

One embodiment of a system for allocating risk of an insurance policy being issued by a lead insurance carrier for a project may include a storage unit configured to store project information associated with the project being covered by the lead insurance policy of the insurance carrier. The project information may include project provisions, contract contingencies, and insurance terms. A processing unit may be in communication with the storage unit, and be configured to collect and store the project information in the storage unit. Another potential carrier may be offered a percentage of the premium and coverage risk associated with the insurance policy by the processing unit. The project information may be made accessible by the processing unit for viewing on an electronic device to the potential other carrier to consider in connection with taking a percentage of the insurance policy. Information associated with the potential other carrier may be stored in association with the project information in response to the lead insurance carrier accepting an offer by the potential other carrier for a percentage of the insurance policy. The percentage of the insurance policy risk and premium may be communicated to the other carrier.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram of an illustrative group of project participants who are taking part in development of a project;

FIG. 2 is a flow diagram describing an illustrative overall process for creating the project development environment of FIG. 1;

FIG. 3A is an illustrative network environment that may be used by project participants to communicate with one another;

FIG. 3B is a block diagram of illustrative software modules for managing a project;

FIG. 4 is a block diagram of an illustrative pre-contract structure that includes a project manager and contract participants who jointly develop a contract that defines a project development;

FIG. 5 is a flow chart of an illustrative pre-contract process for creating a contract, contingencies, and insurance policies for a project development;

FIG. 6 is a screen shot of an illustrative project “dashboard” that may be accessed by the project participants;

FIG. 7 is a flow diagram of an illustrative process for managing a project by a project manager and appeals decider;

FIG. 8 is a screen shot of illustrative integrated contract balances for settling claims for a project development;

FIG. 9 is a screenshot of an illustrative claims submission graphical user interface (GUI);

FIG. 10 is a screen shot of an illustrative project manager decision GUI;

FIG. 11 is a screen shot of an illustrative claims tracking GUI;

FIG. 12 is an interaction diagram showing illustrative interactions between project participants of a development project;

FIG. 13 is a flow diagram of an illustrative claims submission process;

FIG. 14 is a block diagram of an illustrative insurance carrier environment in which a project insurance carrier may insure projects;

FIG. 15 is a block diagram of an illustrative insurance carrier environment in which a project insurance carrier that is carrying an insurance policy for project;

FIG. 16A is an illustration of an illustrative network environment is shown to provide an insurance carrier with the ability to create a secondary market for apportioning insurance policy premiums and risk associated with the insurance policies;

FIG. 16B is a block diagram of an illustrative set of software modules that may be used to manage project insurance policies;

FIG. 17 is a screenshot of an illustrative asset/risk tracker listing;

FIG. 18 is a screen shot of an illustrative auction bid selector GUI that includes a project bid submissions section and an awards entry section for each of the different insurance policies being utilized for the project;

FIG. 19 is a block diagram of an illustrative insurance carrier relationship for a project insurance carrier and secondary insurance carriers;

FIG. 20 is a flow diagram of an illustrative process for apportioning premiums and risks for the insurance policies for a project from one insurance carrier to other insurance carriers; and

FIG. 21 is a flow diagram of an illustrative process for conducting an auction for participation in the premiums and risks for the insurance policies on a project.

### DETAILED DESCRIPTION OF THE DRAWINGS

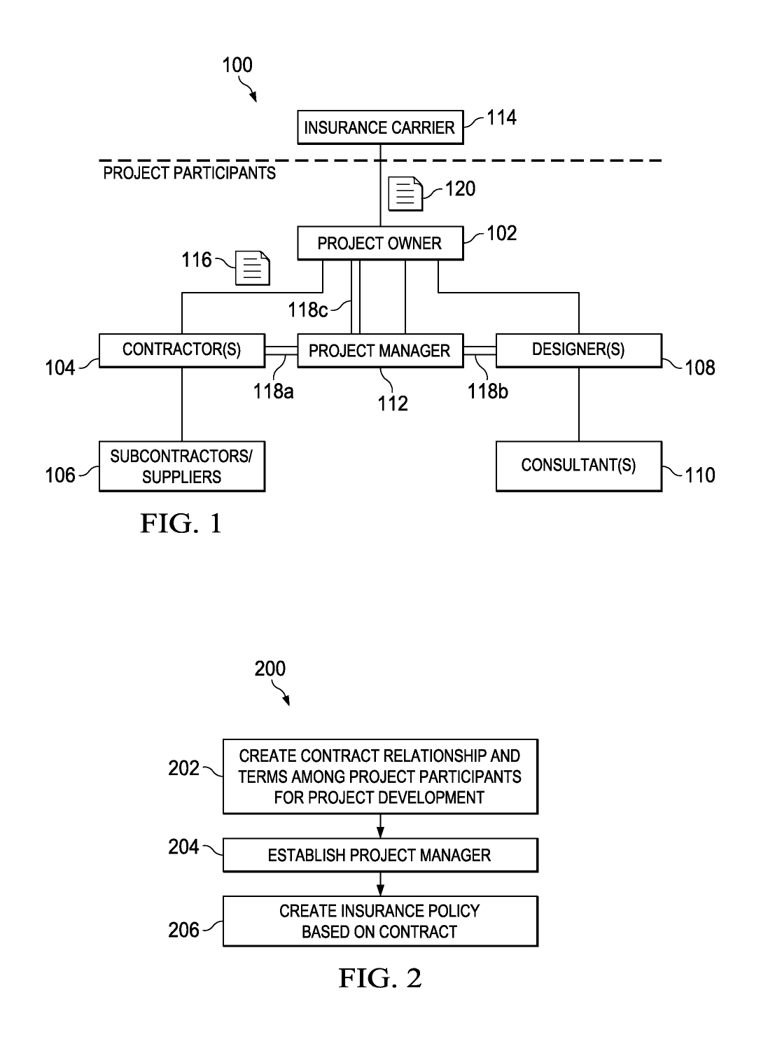

With regard to FIG. 1, a block diagram of an illustrative group of project participants 100 who are taking part in development of a project is shown. The project participants 100 may include a project owner or developer 102, contractor(s) 104, subcontractors/suppliers 106, designer(s) 108, consultant(s) 110, and project manager 112. As shown, an insurance carrier or project insurance carrier 114 may be used to insure the project with the project owner 102 and/or project participants 102-112. Before the development of the project commences, the project participants 102-112 may work out or create a contract 116 that is used to legally and contractually bind each of the project participants 102-112 with one another. The contract 116 may include enforceable contract language in which each of the project participants 102-112 limit and waive their rights to sue any of the other project participants for damages or additional costs with the exception of (i) claims paid by the established contract contingencies or insurance polices or (ii) claims for additional costs to any one project participant caused by the breach by that participant of its underlying contractual obligations (which would be the responsibility of the breaching party subject to the limitations of the contract) or (iii) owner-directed changes to the project scope (which would be the responsibility of the project owner).

As understood in the art, project developments utilize (i) designer(s) 108 who design projects prior to construction and (ii) contractor(s) 104 who build the projects. As previously described, project participants have traditionally been adversarial towards one another for liability reasons. However, as the contract 116 is established prior to initiation of the project development with contractual terms, limits, waivers, and other specifications that put each of the project participants 102-112 on the same side in terms of liability (i.e., without assigning liability to one project participant or another in the event of a problem), the project participants, including the designers 108 and contractors 104, have little or no reason not to work together in a manner that has heretofore been difficult or impossible due to the liability risk associated with not having a direct contractual relationship that includes claim limits and waivers with one another.

A project manager 112 is an individual or group (e.g., company) that manages development of a project. The project manager 112, in this case, maintains the project development under the contract 116. That is, the contract 116 defines scope, cost, schedule, and other definitions and constraints that are used to guide project participants in the project development. In the event of an occurrence or problem, a project manager 112 is contractually authorized by the contract 116 to resolve the problem. As shown, three communication paths 118a, 118b, and 118c (collectively 118) may be used to provide communications between the project manager 112 and contractor(s) 104, designer(s) 108 and project owner 102, respectively, with the project manager 112. In the event that a problem arises, any of the contractor(s) 104, designer(s) 108, or project owner 102 may communicate with the project manager 112 to resolve the problem, such as in the form of a claim to the project manager 112 for compensation or otherwise. The project manager 112 provides active project management that includes dispute resolution through risk management. The project manager 112 provides adjudication services that are contractually binding as defined in the contract 116. In summary, the project manager 112 has two tasks, (i) to work with the project participants to define scope of work and risks, project contingencies, and any other project definitions that the project manager will manage during the project development, and (ii) to function as a real time “risk manager” by performing dispute resolution in response to a claim being submitted by a project participant or a third party.

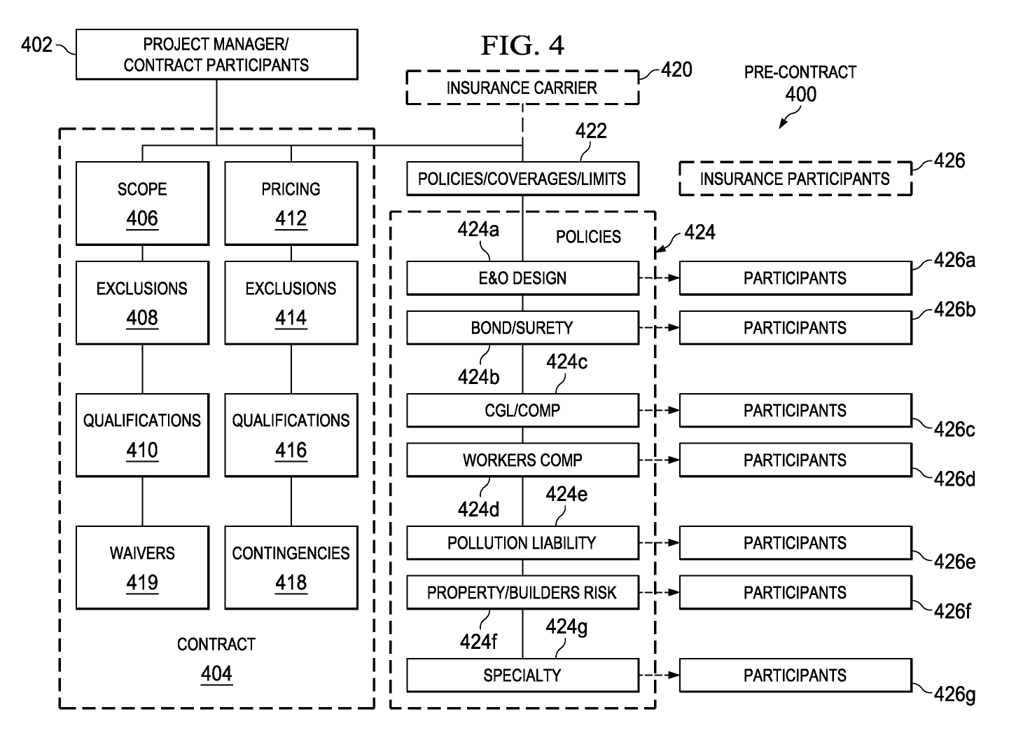

Once the contract 116 is completed and the project participants 102-112 have agreed to the terms of the contract 116, the project owner 102 may obtain an insurance policy 120 with the insurance carrier 114. It should be understood that the project participants 102-112 may be contractually bound by the insurance policy 120, as well, since the project participants 102-112 may participate in making premium payments to the insurance carrier(s), via the project owner to the insurance carrier(s), or through a third-party to the insurance carrier(s) during the project development. The insurance policy 120 may be a single insurance policy or be a set of coordinated insurance policies that cover each of the different areas of risk of the project development, as further described herein with regard to FIG. 4. Because the project as a whole may have a single insurance policy relationship (i.e., between the project owner 102 and project participants 104-112, on the one hand, and insurance carrier, on the other hand, 114 that covers each of the project participants 102-112), the project owner 102 and project participants 104-112 may be better served as they are more likely to work together during the project development. Moreover, the consolidated insurance may operate as a backup to contractual contingencies, as further described herein, that serve as self-insured deductibles or retentions under control of a risk management provider (e.g., project manager 112).

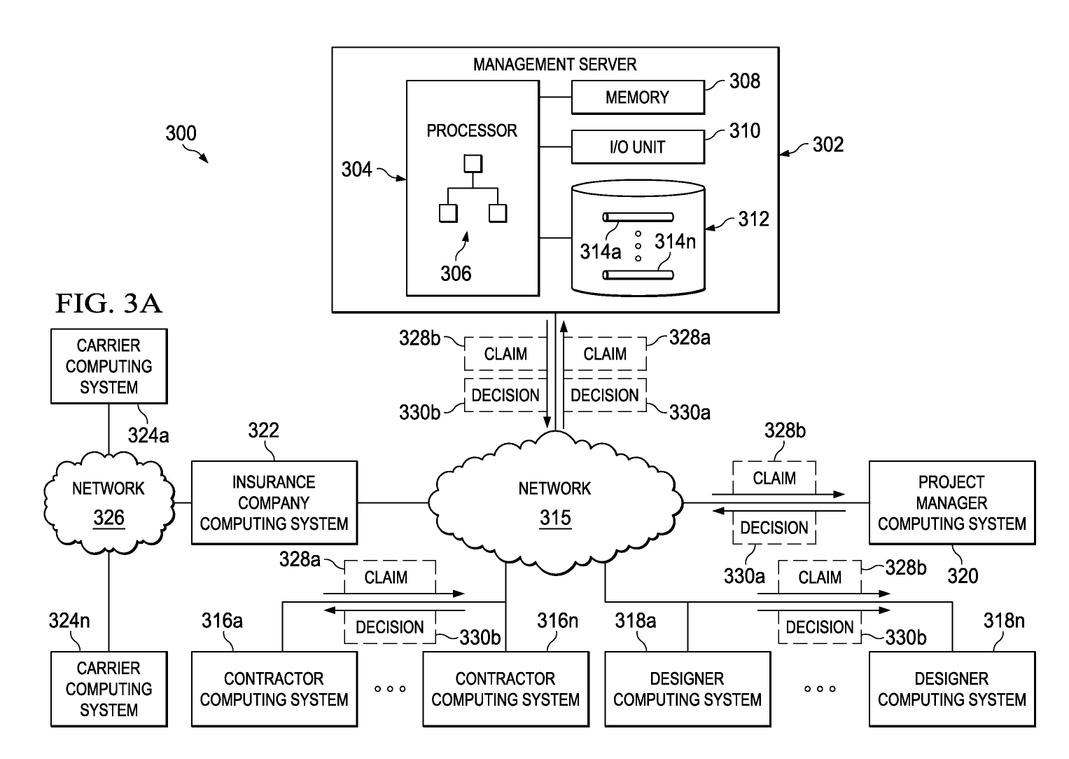

With regard to FIG. 2, a flow diagram describing an illustrative overall process for creating the project development environment of FIG. 1 is shown. The process 200 starts at step 202 in which a contractual relationship and terms of the contract are created among project participants for the project development. The contractual relationship and terms may include scope, price, schedule, and claims limits and waivers between project participants, and any other terms and conditions that may define a project development. In one embodiment, the contractual relationship may be between or among all project participants. In an alternative embodiment, the contractual relationship may be between or among major project participants (e.g., designer, prime contractor, project owner, and project manager). At step 204, a project manager is established. It should be understood that the project manager may be established as part of or before step 202, as well. The project manager position and duties may be contractually defined in the contract created in step 202. At step 206, an insurance policy may be created based on the contract. Because the insurance policy is written on the project during or after the contract among the project participants has been created, the insurance policy may be specific to the project itself, as opposed to being based solely on historical operations of the project participants (e.g., history of a designer who has designed projects of certain types, but not of the type of the instant project).

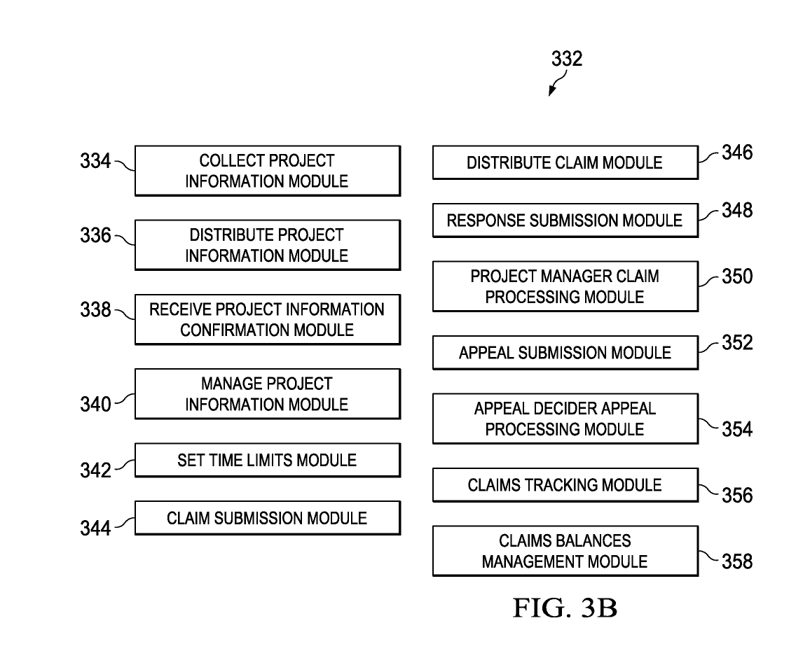

With regard to FIG. 3A, an illustrative network environment 300 that may be used by project participants to communicate with one another is shown. The network environment may include a management server 302 that may be utilized to manage contractual obligations, including claims submissions in response to problems occurring during project development. The management server 302 may be operated by a project owner, third party, project participant, or the project manager. The management server 302 may include a processing unit 304 that executes software 306. It should be understood that the processing unit 304 may include one or more computer processors that may be in communication with one another and be capable of executing the software 306. The software 306 may include modules that are configured to manage a claims submission and handling process, where claims may be submitted by project participants or third parties to request compensation for a problem, such as a design flaw. The processing unit 304 may be in communication with a memory 308, input/output (I/O) unit 310, and storage unit 312. The memory 308 may be configured to store data and/or software that the processor 304 may use in performing the principles of the present invention. The input/output unit 310 may be configured to communicate data locally and remotely from the management server 302. The storage unit 312 may be configured to store one or more data repositories 314a-314n (collectively 314) that may store contract information (e.g., terms of the contract), claims submissions, responses to claims, appeals submissions, and so forth, as further described herein.

The management server 302 may communicate via a communications network 315 with computing systems and/or communication devices (e.g., smart phones) of the project participants. As shown, the management server 302 may communicate with contractor computing systems 316a-316n (collectively 316), designer computing systems 318a-318n (collectively 318), project manager computing system 320, and insurance company computing system 322. It should be understood that if the management server 302 is operated by the project manager, then project manager computing system 320 may simply be incorporated into the management server 302. The insurance company computing system 322 may be in communication with carrier computing systems 324a-324n (collectively 324) via network 326, which may be part of or distinct from network 315, as understood in the art. The carrier computing systems 324 may be utilized to communicate with the insurance company computing 322 to allow for other carriers to bid for a portion of insurance policies that are being created by a primary or lead insurance company that is insuring projects directly.

In one embodiment, a contractor utilizing the contractor computing system 316n may submit a claim 328a to the management server 302 as a result of a problem occurring during construction of a project. For example, the problem may be a delay as a result of a designer incorrectly designing a portion of the project which the contractor is constructing. As a result, the contractor requires more money to correct the problem and avoid delay to the completion of construction (and associated damages that would result from the owner's inability to occupy and use the project as originally scheduled). The management server 302 may receive the claim 328a and, in response, communicate the claim 328b to project participants, including the project manager via the project manager computing system 320. It should be noted that claim 328a is the original claim being submitted to the management server 302, and claim 328b is the same claim that is communicated from the management server 302 to the project participants. The content may be the same, but the format may be different. In one embodiment, rather than the management server 302 actively communicating the claim 328b, the project participants may request download of the claim 328b from the management server 302.

The project manager computing system 320 may be configured to enable the project manager to view the claim 328b and upload a decision 330a to the management server 302. In one embodiment, the management server 302 may be configured to provide a graphical user interface (GUI), such as a webpage, for project participants to submit claims and for the project manager to submit decisions. As shown, the management server 302 may be configured to receive the decision 330a and communicate the decision 330b to other project participants via the network 315. Although not shown, claims and decisions may be communicated to the insurance company computing system 322 so that the insurance company may monitor claims processing prior to the project manager submitting a claim to the insurance company for payment. FIG. 3 does not show appeals to project manager decisions, however, the principles of the present invention provide for appeals to be submitted by project participants to an appeals decider, and the appeals decider to submit decisions of the appeals to the management server 302 to be stored in association with the project information. In the case of having an appeals decider, an appeals decider computing system (not shown) may be utilized to communicate with the management server 302 to communicate therewith, such as communicating appeals and decisions of the appeals.

While the network environment 300 shows that the principles of the present invention may be computerized to provide for communications between project participants, it should be understood that the fundamentals of a project are generally negotiated by human beings in the same room. Because projects that would typically have these integrated contracts and insurance policies are typically large, such as hundreds of millions or billions of dollars for the project development, the project participants are generally brought together prior to the commencement of the project development and before an insurance policy is created. For the purposes of this application, an insurance policy may be formed of multiple insurance policies of different categories that are coordinated with one another to insure the project.

Because the project participants are able to work with one another with little or no concern for liability issues as a result of the limitations and waivers being specified in the project contract to which the project participants are contractually bound, the management server 302 may be configured to provide a document sharing platform for the project participants. In one embodiment, the data repositories 314 may provide for a database of documents being produced for the project by each of the project participants, whereby each of the project participants that have access to the database may access the documents contained therein. It should be understood that certain business rules may be created to allow certain documents to be accessible to the project participants on a need-to-know or other basis (with related confidentiality terms being acknowledged and accepted). As an example, design documents or a subset of the design documents for a garage may be limited to the garage designers, construction group constructing the garage, and project manager, while design documents or a subset of the design documents for a corresponding hotel may be limited to the hotel designers, construction group constructing the hotel, and project manager. It an alternative embodiment, all documents in the database may be available to all project participants.

With regard to FIG. 3B, a block diagram of illustrative software modules 332 for managing a project is shown. The software modules 332 may be executed on the management server 302, and may include a collect project information module 334 that may enable a user to enter project information. The module 334 may enable contract terms to be entered and stored in a data repository via a GUI, for example. The contract terms may include project participant information, contract contingency information, project manager information, and insurance information. The module 334 may include at least a portion of a common set of contract terms to be entered. Alternatively, the contract terms may be different for each type of project (e.g., stadium project versus offshore oil rig drilling project). As an example, the contractual terms may follow industry standard categories and definitions, such as those of the American Institute of Architects, the Construction Specifications Institute or other construction or manufacturing organization, as understood in the art.

A distribute project information module 336 may be configured to distribute the project information to project participants. The distribution may be made in response to a project participant logging onto a system via a communications network, for example. Alternatively, the distribution may be made through conventional download, email, or other electronic communication.

A receive project information confirmation module 338 may be configured to receive a communication from a project participant to confirm or deny contract terms. In response to receiving a confirmation or denial, the module 338 may store the confirmation or denial in association with the project participant and the project information. A project manager or owner may address any denials through further negotiations with the project participant(s).

A manage project information module 340 may be configured to manage project information that is being stored in a data repository 314a by the management server 302. The module 340 may enable a user, such as the project manager, to update the project information during the course of the project. For example, during the project, as additional details of the project are developed, additional scope, price, schedules, and other information may be updated by utilizing the module 340.

A set time limits module 342 may be configured to utilize contractual terms to establish time limits for a variety of actions to occur during a project. In one embodiment, the time limits may include a (i) time limit for a response to be submitted to a claim by project participants, (ii) time limit for a project manager decision to be made, (iii) time limit for an appeal to be filed after a project manager submits a decision to a claim, (iv) time limit for an appeals decider to submit a decision to an appeal, and (v) time limit for the project manager to dispose of a claim after the appeals process has been completed, if an appeal has been submitted. Additional and/or different time limits may be established and managed by the module 342. In addition to setting the time limits, the module 342 may be utilized to report and track the time limits during the claims process.

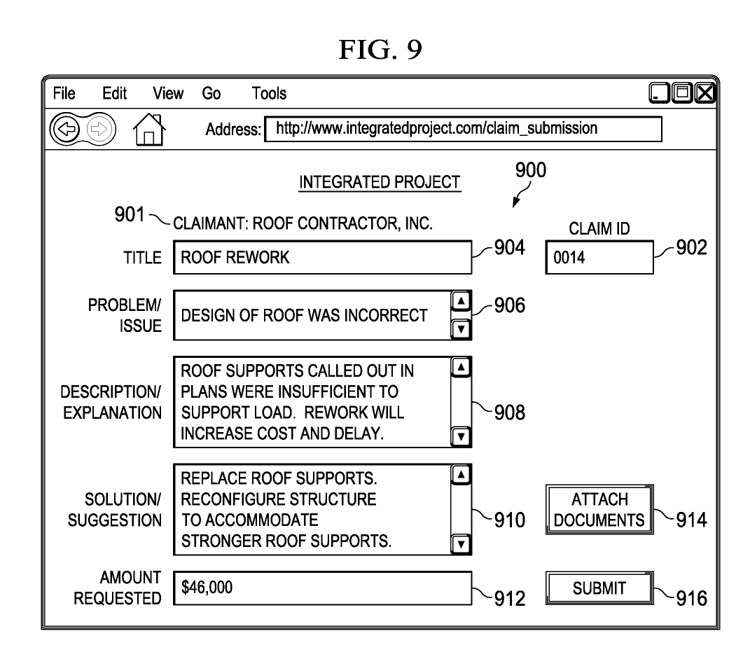

A claim submission module 344 may be configured to enable a project participant to submit a claim. The module 344 may be configured to provide a GUI, such as the GUI shown in FIG. 9, for a project participant to utilize when submitting a claim. The module 344 may further be configured to receive and store a claim submission, including associating any documents submitted with the claim with the claim information.

A distribute claim module 346 may be configured to distribute claim information to project participants after a claim is submitted. The module 346 may be configured to distribute the claim to the project participants automatically or in response to a project participant logging onto a project management system. In one embodiment, the module 346 may be configured to communicate a link to a claim via an email, for example, that, in response to a project participant selecting the link, launches a webpage that presents the claim to the project participant.

A response submission module 348 may be configured to provide a project participant with the ability to submit a response to a claim in the same or similar manner as the claim submission module 344. However, the module 348 may present a claim to the project participant and provide text entry fields for the project participant to submit a response. In response to receiving the response, the module 348 may be configured to store the response in association with the claim. The module 348 may use the claim ID in storing the response in association with the claim, for example.

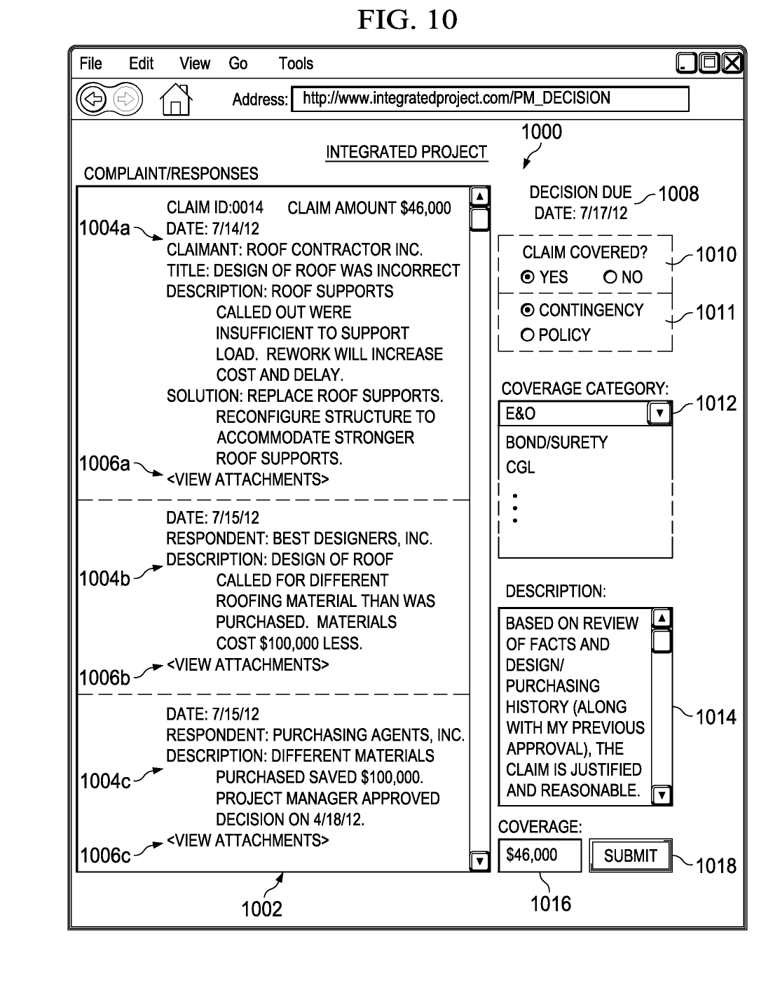

A project manager claim processing module 350 may be configured to manage a claim submission process. For example, the module 350 may be configured to notify the project manager about a claim submission and response submission. Furthermore, the project manager may be presented with the claim and response, as provided in FIG. 10, and enable the project manager to submit a decision along with a description and amount for the claim. The module 350 may further be configured to store the decision with the claim and response(s) in a data repository.

An appeal submission module 352 may be configured to enable a project participant to submit an appeal. The module 352 may be configured to present a GUI to a project participant with text entry fields that a project participant may utilize to submit an appeal. The module 352 may further be configured to store the appeal in association with the claim, such as by associating the appeal with the claim ID.

An appeal decider appeal processing module 354 may be configured to enable an appeal decider to submit a decision to an appeal. The module 354 may be configured to generate a GUI in which the appeal decider may enter the appeal decision. The GUI may provide access to the claim, response(s), project manager decision, appeal(s), and project information, for example. With the other claim processing modules 344-352, a time limit may be provided to the appeals decider in the form of a message or display on the GUI (e.g., countdown clock).

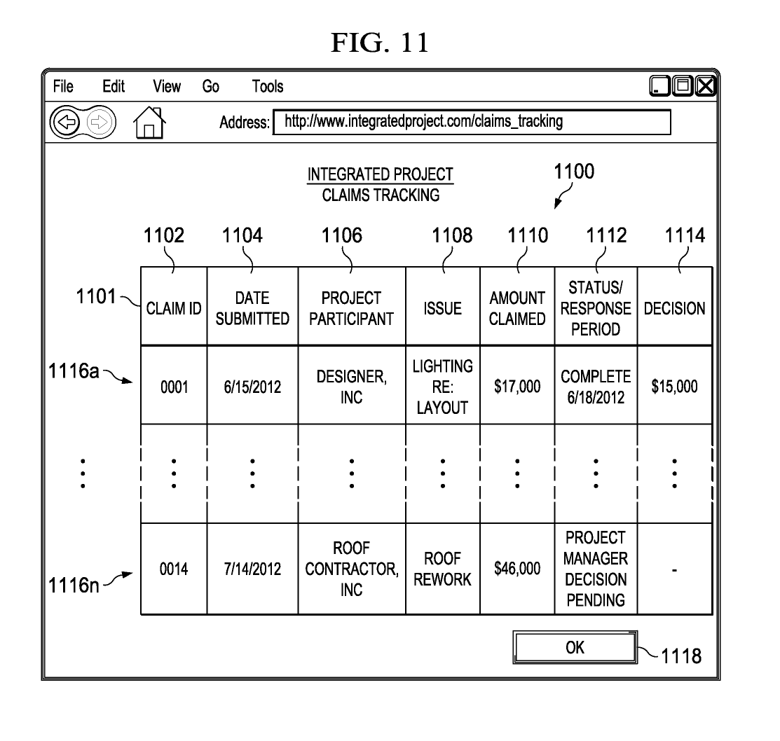

A claims tracking module 356 may be configured to display a claim summary listing in a tabular form, for example, on a GUI. The claim summary listing may be one shown in FIG. 11. The module 356 may be accessible to the project participants, and automatically update based on status updates by other modules to the data repository that is managing the claims process.

A claims balances management module 358 may be configured to manage balances of insurance policies and contract contingencies. The claims balance accounts may separately identify contract contingencies and insurance policy balances. In one embodiment, the module 358 may enable the project manager to manually adjust the balances. In an alternative embodiment, the module 358 may interface with an accounting system, such as an insurance accounting system, online banking account, or other system that is adjusted in response to a claim actually being paid from the applicable contingencies and/or insurance policies.

With regard to FIG. 4, a block diagram of an illustrative pre-contract structure 400 is shown to include a project manager and contract participants 402 who jointly develop a contract 404 that defines a project development. The contract 404 is shown to include scope 406, exclusions 408, and qualifications 410, where each of these are contractual terms within the contract 404. The contract 404 may further include pricing 412, exclusions 414, qualifications 416, and contingencies 418, where each of these is a term of the contract 404. It should be understood that a wide variety of other provisions may be included in the contract 404, including provisions that define the role and scope of the project manager, requirements for submitting claims to the project manager, timelines by which the project manager are required to respond to the claims and/or make decisions for the claims, an appeal process to the project manager's decisions, and timeline by which appeals need to be decided. Furthermore, the contract 404 may include limitations and waivers of claims 419 that are legally binding to limit liability amongst the project participants. By including the limitations and waivers 419 in the contract 404, the project participants who are signatures to the contract 404 will not be in an adversarial position to one another, thus providing for better cooperation between one another so as to focus on development of a successful project.

An insurance carrier 420 that insures the project may set forth policies/coverages/limits 422 for various categories of insurance coverages. The insurance coverages may be placed into a set of insurance policies 424, including an E&O design policy 424a, bond/surety policy 424b, commercial general liability (CGL)/completed operations insurance policy 424c, workers compensation policy 424d, pollution liability policy 424e, property/builders risk policy 424f, and specialty policy 424g. These policies 424 are illustrative, and it should be understood that additional and/or alternative policies that are to be used to provide coverage to the project participants may be utilized in accordance with the principles of the present invention. Although not shown, the contract contingencies 418 that are specified in the contract 404 may provide for individual pools of money that are categorized in the same manner as the policies 424. The contract contingencies 418 that are specified may be a percentage value of the coverages/limits 422 of liability under the contract 424. For example, an E&O contingency may be 15% of an overall E&O liability limitation (e.g., a $100 million E&O liability exposure/limit may be divided into a $15 million contract contingency and $85 million insurance policy). In one embodiment, a single insurance policy may include multiple categories of sub-policies, as listed above. Alternatively, the policies may be separate from, but associated and, possibly, integrated with, one another. In either case, the project insurance carrier may apportion the risk for the sub-policies or individual policies to insurance participants, such as secondary insurance carriers, as further described herein.

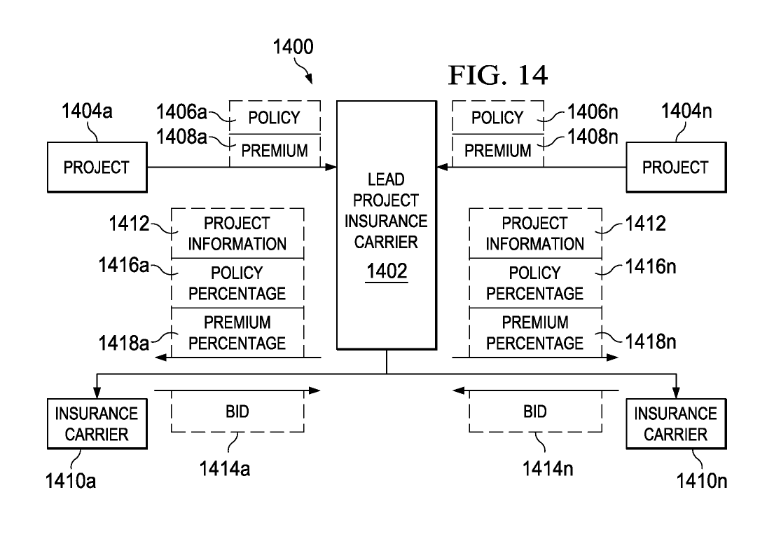

Once the insurance carrier 420 has established the insurance policies 424 with the project owner, the insurance carrier 420 may elect to apportion the risk and premiums of the policies 424 with other potential insurance participants 426. As shown, the insurance participants 426a-426g may receive or be apportioned risk and premiums from the respective policies 424a-424g. Each of the potential insurance participants 426 may be provided the project information, including the contract 404, project participant information, and insurance policies 424 with the coverages and limits 422 incorporated therein to assist the potential insurance participants 426 in making a decision as to whether or not to participate in the insurance 424 and, if so, how to price the applicable premium to be paid to the insurance participant for a particular percentage of the risk of the respective insurance policies 424. Further description of the insurance participants 426 is described herein with regard to FIGS. 14-21.

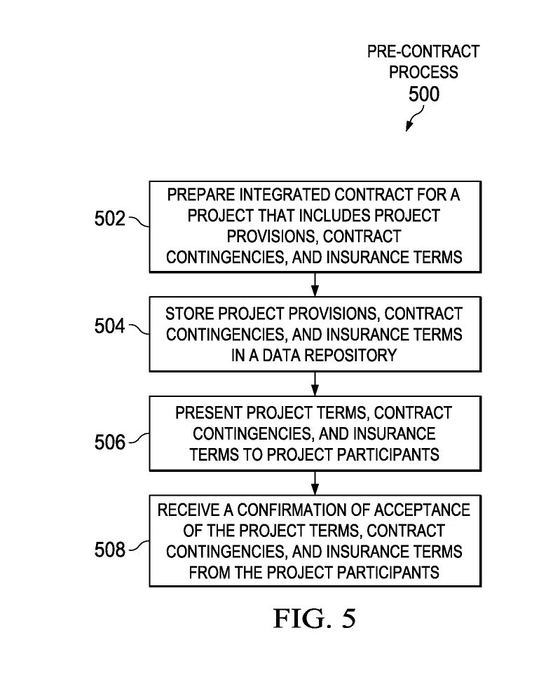

With regard to FIG. 5, a flow chart of an illustrative pre-contract process 500 for creating a contract, contingencies, and insurance policies for a project development is shown. The process 500 starts at step 502, where an integrated contract is prepared for a project that includes contract terms and project responsibilities related to a specific project, contract contingencies, and insurance coverage and limits. The integrated contract is a contract among project participants that may be used to reduce or eliminate the need for the project participants to have insurance directly with an insurance carrier, other than the project policies with the insurance carrier, covering their participation in the project. At step 504, contract terms/project responsibilities, contract contingencies, and insurance coverage and limits may be stored in a data repository.

At step 506, contract terms/project responsibilities, contract contingencies, and insurance coverage and limits may be presented to the project participants. The presentation of the contract terms/project responsibilities, contract contingencies, and insurance coverage and limits may be presented to enable the project participants to view and approve of the contract and insurance prior to initiating the project. At step 508, a confirmation of acceptance of the contract terms/project responsibilities, contract contingencies, and insurance coverage and limits may be received from the project participants. Once each of the project participants has approved of the basic terms of the project, then the project may be initiated.

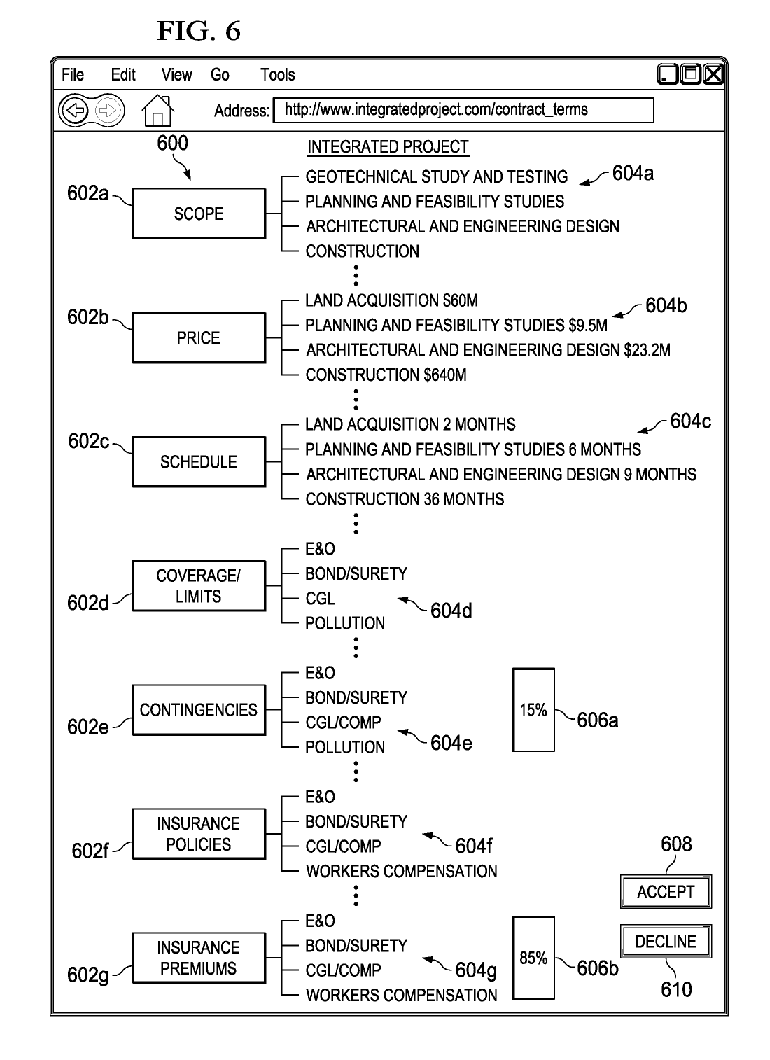

With regard to FIG. 6, a screen shot of an illustrative project “dashboard” 600 that may be accessed by the project participants is shown. A number of different soft-buttons 602a-602g are shown to enable a user to select to view details of the associated topic, including project scope, price, schedule, coverage/limits, contingencies, insurance policies, and insurance premiums. It should be understood that these topics are illustrative and that additional and/or alternative topics may be listed. In one embodiment, in response to a user selecting one of the soft-buttons 602a-602g, details 604a-604g associated with the topic of the associated soft-button may be shown. For example, if a user selects the scope soft-button 602a, a number of different selectable items within the scope, such as geotechnical study and testing, planning and feasibility studies, architectural and engineering design, construction, and so forth may be displayed or listed. Each of the items that are displayed may be selectable so that the user may select an item and see details within that item. For example, if a user selects geotechnical study, certain aspects of the soils conditions for the project site may be shown, including test boring results and related data. Alternatively, rather than the user having to select the soft-button 602a, in response to the user placing a cursor over the scope soft-button 602a, the items 604a within the topic may be displayed and selectable, as understood in the art. Still yet, in response to selecting one of the soft-buttons 602a-602g, a separate screen (not shown) may be displayed to show details of the topic associated with the selected soft-button.

In addition to showing items associated with topics, two percentages 606a and 606b may be shown to indicate what percentages are to be applied for contingencies and insurance premiums, respectively. That is, contract contingencies are meant to be a project specific deductible to be exhausted prior to a claim having to be made to an insurance policy for the project participants. The percentages shown are illustrative, and other percentages may be used in accordance with the principles of the present invention. After a project participant has had the opportunity to view the contents stored by a computing system and presentable in the project “dashboard” 600, a user may select an “accept” soft-button 608 or “decline” soft-button 610. If the user selects the “decline” soft-button 610 then the user may be presented with a text entry field to enable the user to enter information as to why he or she declined the project terms. In an alternative embodiment, “accept” and “decline” soft-buttons (not shown) may be associated with each of the different topics to be selectable by the project participant. In addition to the project “dashboard” 600 being used for project participants to accept or decline terms of the contract, the same or similar dashboard may be utilized to enable a project manager to monitor contract terms during project development. It should further be understood that as the project development moves forward, additional contract terms, schedule revisions, contract revisions, or any other updates to the project definitions and information may be stored and displayable in the project “dashboard” 600, and project participants may additionally be requested and/or required to accept additions and/or changes to the terms of the contract.

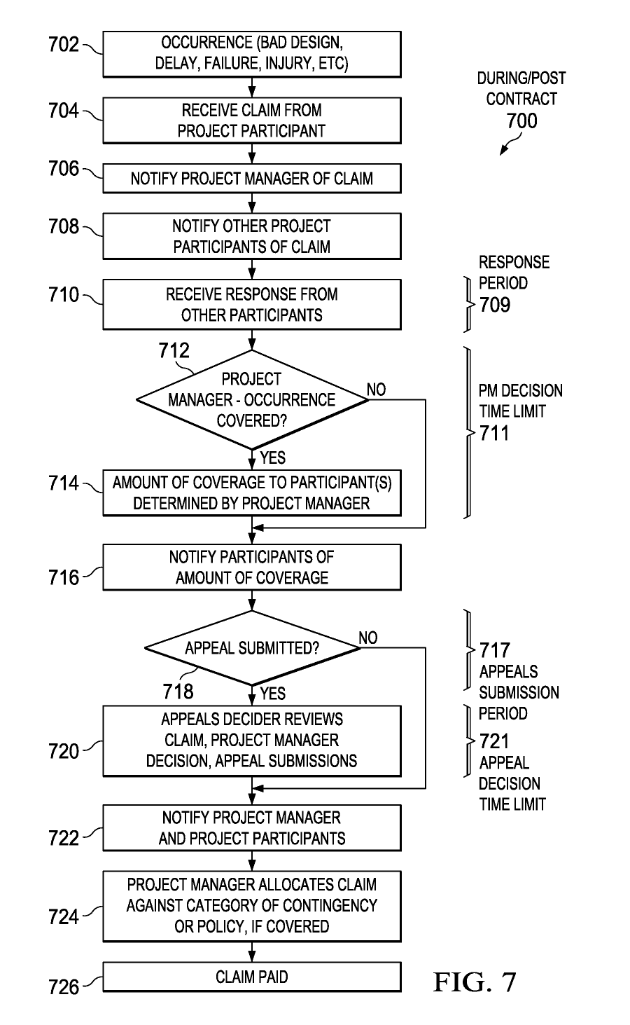

With regarding to FIG. 7, a flow diagram of an illustrative process 700 for managing a project by a project manager and appeals decider is shown. The process 700 starts at step 702, where an occurrence or problem may happen. An occurrence associated with a project may include discovering that a bad design or error in design has happened, a delay is occurring or soon to occur, a failure in a part of a project has occurred, an injury has happened, or any other occurrence associated with a project may be discovered. At step 704, a claim from a project participant may be received. In one embodiment the claim may be submitted via a computer network to a project manager, as specified in the contract for the project. At step 706, a project manager may be notified of the claim submitted by the project participant. In notifying the project manager, an electronic notification may be made, including sending an email, text message, or display in a system that is being used by the participants of the project for managing the project.

In addition to notifying the project manager of the claim at step 706, other project participants may be notified of the claim at step 708. In one embodiment, all of the other project participants may be notified of the claim. Alternatively, project participants related to the claim may be notified. However, because the principles of the present invention provide for a “team atmosphere,” notification to all project participants may be appropriate. After notification of the other project participants of the claim at step 708, a response period 709 may commence. The response period may be a set period of time, such as 48 hours, that is specified in the project contract that has been approved by the project participants, and provides for other project participants to provide a response or comment about the claim. At step 710, one or more responses may be received from the other project participants. The claim and responses that had been submitted by the project participants may be presented or accessed by the project manager to enable the project manager to make a decision as to whether the occurrence is covered by a contract contingency and/or insurance policy of the project.

The project manager may have a decision time limit 711 after all responses have been received from the project participants or after the response period 709. The decision time limit 711 may be established in the contract of the project. Because the project manager may be contractually bound to make a decision within a time period, as compared to conventional processes where decisions are made between two parties or two project participants using traditional legal means, a decision made by the project manager may be considered real-time. If, at step 712, a decision is made that the occurrence is covered by a contract contingency and/or insurance policy, then the amount of coverage to be given to the project participant(s) may be determined by the project manager at step 714. At step 716, notification to the project participants of the amount of coverage may be made. The notification may be made via an electronic communication, including posting on a webpage or communicating via an email, text message, or otherwise may be utilized. If, however, a decision at step 712 is made that the occurrence is not covered by a contract contingency and/or insurance policy, the process 700 may skip steps 714 and 716. The project participants may be notified that the occurrence is not covered at step 716. After notification to the project participants of the coverage or lack of coverage of the occurrence, an appeals submission period 717 may commence. As with the other periods, the appeals submission period may be contractually specified in the contract for the project participants who are working on the project. In one embodiment, the appeals submission period may be three business days.

At step 718, a determination may be made as to whether an appeal has been submitted. If an appeal has been submitted by one of the project participants, then the process continues at step 720, where an appeals decider may review the claim, project manager decision, and appeal submission. An appeal decision time limit 721 may provide the appeals decider a certain specified time limit by which a decision has to be made on the appeal. In one embodiment, the appeals decision may be required to be made within five business days to allow for the project participants to continue moving forward. Alternative time limits may be specified in the contract of the project to which the project participants have agreed. Again, the time limits provided to the project manager, project participants, and appeals decider may be relatively short to allow for the project to have minimal delays due to problems or occurrences during the project.

If no appeals have been submitted within the appeals submission period 717 or an appeal had been submitted and the appeals decider makes the decision at step 720, the process continues at step 722, where the project manager and project participants are notified of the decisions or lack of appeals. At step 724, the project manager allocates the claim against a category of a contract contingency or insurance policy if the occurrence is covered. At step 726, the claim is paid to the project participant that has submitted the claim. The project manager may pay a claim from a contract contingency if the contract contingency has sufficient funds to make the payment. Alternatively, if the contract contingency does not have sufficient funds to pay the claim, then the project manager may submit the claim to the insurance company for payment.

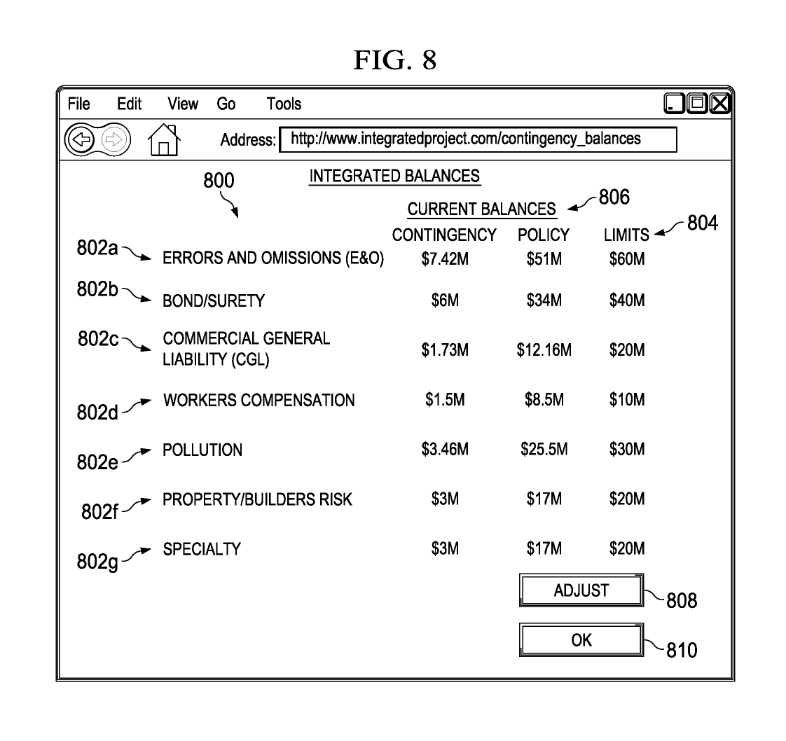

With regard to FIG. 8, a screen shot of illustrative integrated contract balances 800 for settling claims for a project development is shown. Different categories of contract contingencies and insurance policies may include errors and omissions 802a, bond/surety 802b, commercial general liability 802c, workers compensation 802d, pollution liability 802e, property/builder's risk 802f, and specialty 802g. These categories are illustrative, and it should be understood that additional and/or alternative categories of insurance may be utilized in accordance with the principles of the present invention. For each of the different categories of claims, where the applicable coverage limits are intended to describe both contract contingency and insurance policy, limits 804 are shown. For example, a limit for errors and omissions claims for the project may be $60 million. That $60 million may be apportioned to a contract contingency and insurance policy. In one embodiment, the apportionment may be set to 15% for contract contingencies and 85% for the insurance policy. The apportionment may be equal for each of the categories. Alternatively, the apportionment may be individually set for each of the different claims categories (e.g., 80%/20% for a first category, 75%/25% for a second category, and 85%/15% for a third category). Current balances 806 for each of the different categories of claims coverage may be shown. A project manager may view the current balances of a particular contract contingency and insurance policy, and determine whether there are sufficient funds to satisfy or pay for a claim that is made against the particular category from either the contract contingency or insurance policy. Because the contract may specify a maximum amount for a single payout of a claim, the project manager may ensure that the claim payout is in accordance with the contract terms. The project manager may select an “adjust” soft-button 808 to adjust the current balances of the contract contingency or insurance policy by entering or selecting a claim amount or claim that the project manager is currently resolving. Alternatively, the adjustment of the balances may be made automatically by accessing an accounting system or by accessing records of an insurance carrier. Upon selection of the claim or direct adjustment to the value of the current balance, the project manager may select an “okay” soft-button 810 to complete management of the balances of the contingency and insurance categories.

With regard to FIG. 9, a screenshot of an illustrative claims submission graphical user interface (GUI) 900 is shown. The claims submission GUI 900 may include a name of the claimant 901, which may be automatically inserted due to knowing what project participant is logged onto the system. A claim identifier 902 may be automatically generated and posted so that the system may automatically track how many claims have been submitted to the project and manage the claim flow process through the project manager and appeals decider.

A title text entry field 904 may allow for a claimant to provide a title to the claim. A problem/issue text entry field 906 may allow for the claimant to enter a brief claim description. A description/explanation text entry field 908 may enable the claimant to submit a complete description of the problem and provide any explanation that may be helpful for the project manager, other project participants, appeals decider to consider the claimant's suggestion and/or solution to the problem. A solution/suggestion text entry field 910 may enable the claimant to submit a suggestion or solution to the problem so the project manager, other project participants, and appeals decider may consider. An amount requested text entry field 912 may enable the claimant to submit a specific amount for the claim cost to resolve the problem or occurrence that is being identified. An “attached documents” soft-button 914 may enable the claimant to attach any documents, such as photographs, drawings, or any other documents that the project manager, other project participants, and/or appeals decider may consider helpful in reviewing the claim. Upon completion of the claim entry, the claimant may select a “submit” soft-button 916 and the claim may be submitted to a computing system, such as the management server 302 (FIG. 3) for storage and further processing.

After submission of the claim, the system may send out or post notifications for the project manager and other project participants to view the claim. In one embodiment, the project participants may have a time limit by which a response may be submitted to the claim. Although not shown, a graphical user interface showing the claim and having text entry fields to submit a response, attached supporting documents, and providing other information may be made available to the project participants in the same or similar manner as the graphical user interface shown in FIG. 9 for the claimant. Upon the other project participants submitting a response, the response may be stored in association with the claim, and made available to the project manager, other project participants, and the appeals decider. It should further be understood that an insurance carrier may have access to the claims, responses, and any other information that may have a payout due against a contract contingency or insurance policy.

With regard to FIG. 10, a screen shot of an illustrative project manager decision GUI 1000 is shown. A text display box 1002 may show a listing of the original claim 1004a, response from another project participant 1004b, and response 1004c from another project participant. With each of the responses, “view attachments” links 1006a-1006c may be provided for the project manager to select and view attachments made by any or all of the project participants.

In one embodiment, the GUI 1000 may display a decision due date 1008 by which the project manager is contractually bound to finalize a decision on the claim. In making the decision, the project manager may select one of the soft-buttons 1010 to indicate whether the claim is covered or not, and, if so, select one of the soft-buttons 1011 to indicate whether the claim is covered by a contract contingency or insurance policy. If the claim is covered by contingency or insurance, then the project manager may select which contingency or insurance category to use to cover the claim (e.g., E&O, bond/surety, CGL, etc.) by using GUI element 1012. The project manager may also be provided a text entry field 1014 to enter a description to explain his or her decision for the claimant, other project participants, appeals decider, and insurance carrier. A coverage text entry field 1016 may further allow the project manager to enter an amount that the project manager decides is to be covered for the claim. Upon completion of the project manager's decision, the project manager may select a “submit” soft-button 1018 to submit his or her decision to the system. It should be understood that the data fields provided here for the project manager to make his or her decision is illustrative, and other and/or alternative data fields may be provided to the project manager making his or her decision.

With regard to FIG. 11, a screen shot of an illustrative claims tracking GUI 1100 is shown. The GUI 1100 may include a chart 1101 that includes a number of different categories, including claim ID 1102, date submitted 1104, project participant 1106, issue 1108, amount claimed 1110, status/response period 1112, and decision 1114. As shown, a listing of each of the claims 1116a-1116n is shown. Each of the claims may be selectable by the project manager clicking on one of the rows of the claims. In response to the project manager selecting a claim, a full listing of the claim may be displayed. The claims tracking chart 1101 may include other information, but may primarily be used to allow a project manager or other project participant to view status of the claims.

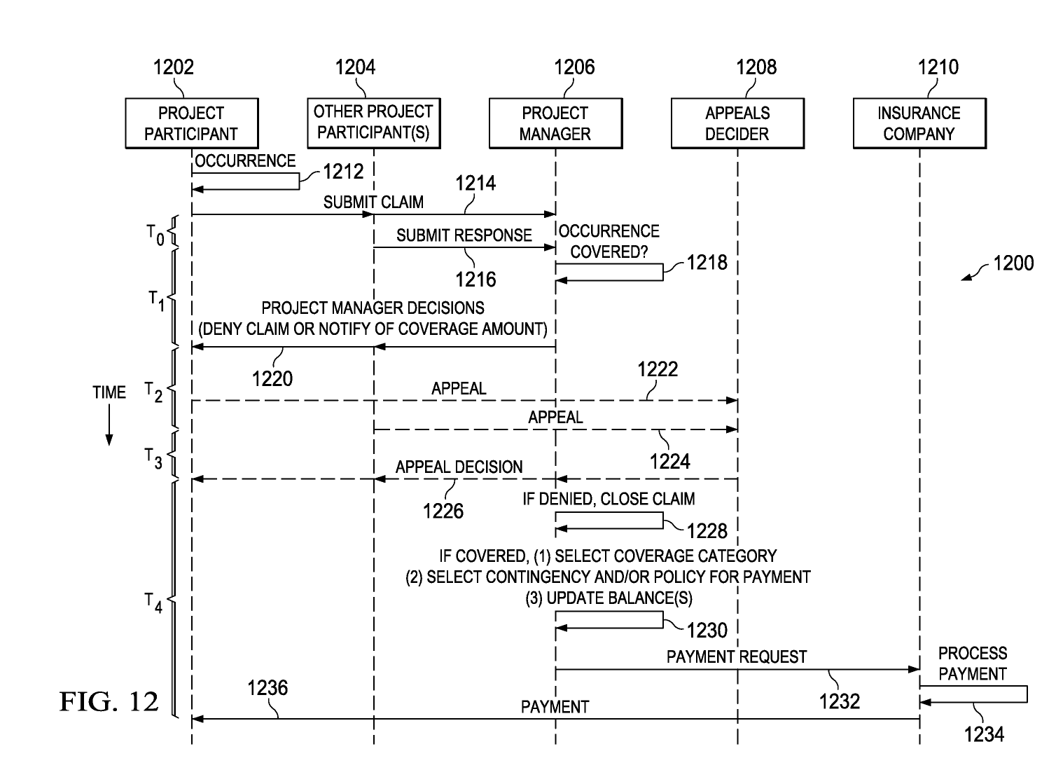

With regard to FIG. 12, an interaction diagram showing illustrative interactions 1200 between project participants of a development project is shown. The project participants may include project participant 1202, other project participant(s) 1204, project manager 1206, and appeals decider 1208. Insurance company or carrier 1210 is also shown. At step 1212, the project participant 1202 may identify an occurrence or problem. As an example, the occurrence may include a situation that is going to cause the project participant 1202 to spend more money or time than originally budgeted by the project participant 1202. As a result, the project participant 1202 may submit a claim at step 1214. The contract for the project may specify a time period of T₀, such as one or two business days, for the other project participant(s) 1204 to submit a response to the claim, which was sent to both the project manager 1206 and other project participant(s) 1204 at step 1214. As previously described, the time period T₀, and other time periods, may be managed and monitored by a computing system operating the process shown in FIG. 12. At step 1216, other project participant(s) 1204 may submit a response to the project manager 1206. Although the claim and response are shown to be communicated to the project manager 1206, it should be understood that the claim and response may be submitted to a third party or otherwise, and then communicated to the project manager 1206. From the time that the response time period T₀ is complete, the project manager 1206 may have a time period of T₁ to make a decision and submit the decision for the claim.

At step 1218, the project manager 1206 may determine whether the occurrence is covered by one or more insurance policies and/or contract contingencies. The project manager 1206 may either deny the claim or notify the project participant 1202 and other project participant(s) 1204 of the coverage amount. Once the project manager 1206 has submitted his or her decisions, then a time period of T₂ may be started during which time the project participant 1202 and other project participant(s) 1204 may appeal the decision of the project manager 1206. As shown, an appeal 1222 may be filed by the project participant 1202 and appeal 1224 may be filed by the other project participant(s) 1204 to the appeals decider 1208.

As may be contractually required, a time period of T₃ may be contractually set for the appeals decider 1208 to provide an appealed decision. In one embodiment, the appeals decider 1208 may have a time period of three business days to make and report a decision for the appeal. The computing system may notify the appeals decider 1208 of the deadline and monitor the submission of the appeal decision by the appeals decider 1208. At step 1226, the appeals decider 1208 may report the appealed decision to the project participant 1202 and other project participant(s) 1204. Again, the contract may specify a time period T₄ after completion of the appeals process for the project manager 1206 to dispose of the claim process (i.e., close or pay on the claim). At step 1228, the project manager 1206 may close the claim if the claim was denied by the project manager 1206 and upheld by the appeals decider 1208, if appealed. In closing the claim, the project manager 1206 may interact with a claims tracking system to set an indicator or flag via a GUI element, for example, to close the claim. Alternatively, at step 1230, if the claim is determined to be covered, then the project manager 1206 may (i) select a coverage category for the claim, (ii) select whether the claim is to be paid by a contract contingency and/or insurance policy for payment, and (iii) optionally update one or more balances for the insurance policy and/or contract contingency. At step 1232, the project manager 1206 may submit a payment request to the insurance company 1210. The insurance company 1210 may process the payment at step 1234. In one embodiment, the insurance company 1210 manages both the contract contingencies and insurance policies, so the project manager 1206 may submit for payment to the insurance carrier 1210 whether the project manager 1206 elects to pay the claim from either the contract contingencies or insurance policies. At step 1236, the insurance company 1210 may directly pay the payment on the claim to the project participant 1202.

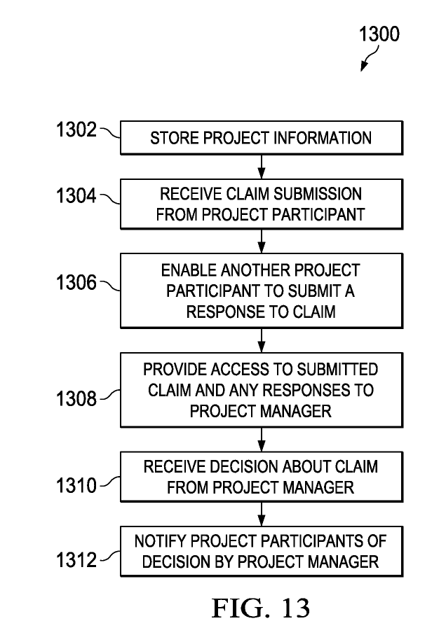

With regard to FIG. 13, a flow diagram of an illustrative claims submission process 1300 is shown. The process 1300 starts at step 1302, where project information may be stored. The project information may be stored in a data repository on a storage unit. The project information may include a wide variety of information associated with the project, including contract provisions, payment terms, names of project participants, contact information of project participants, schedules, contract contingencies, insurance policy terms, and so on. At step 1304, a claim submission may be received from a project participant. In one embodiment, the claim submission may be received by a computing system that is in communication with a storage unit that stores the project information. The claim submission may be submitted via a communications network, such as the Internet and/or mobile network, by the project participant submitting information associated with a problem that is related to the project information.

At step 1306, another project participant may be enabled to submit a response to the claim. In one embodiment, the other project participant may be provided with a graphical user interface that lists the claim that was submitted and allow the other project participant to provide a response, which may include text and attached documents. At step 1308, access to the submitted claim and any responses may be provided to the project manager. The project manager may be provided access by receiving a notification that alerts the project manager of the claim and responses having been submitted and enables the project manager to access the claim and responses via a communications network.

At step 1310, a decision about the claim may be received from the project manager. The decision may be stored in association with the claim and responses in a data repository, such as a database. At step 1312, the project participants may be notified of the decision by the manager. In notifying the project participants, the computing system may communicate a data message or post a notification to an account of the project participants. In communicating a data message, the data message may be in the form of an email or text message, as understood in the art. Although not shown, it should be understood that similar processes may be provided to provide for the processes shown in FIGS. 7 and 12.

With regard to FIG. 14, a block diagram of an illustrative insurance carrier environment 1400 in which a project insurance carrier 1402 may insure projects 1404a-1404n (collectively 1404) is shown. The projects may be large-scale projects (e.g., $100,000,000 or more) and be developed under a contract with project participants as previously described herein. Each of the projects 1404 may have an insurance policy 1406a-1406n (collectively 1406) that is provided to an owner of the projects 1404. As previously described, the insurance policies 1406 may be issued to support an entire project and the project participants who have agreed to limits and waivers of claims within the contract for the project. Once the project insurance carrier 1402 has issued the policy, the project participants may pay premiums 1408a-1408n (collectively 1408) to the project insurance carriers 1402. The premiums 1408 may be used to pay for contract contingencies and insurance policies, as described herein.

Historically, and as previously described, project participants held separate insurance for participating in a project. However, in accordance with the principles of the present invention, it is possible that a single insurance carrier insures most or all of the participants and risks on a project. In one embodiment, the risks insured are all of the risks that may be considered insurable, as understood in the art. And, because the projects contemplated to utilize the principles of the present invention are to be very large, a single insurance carrier is unlikely willing to carry the entire risk for the project. As such, the principles of the present invention provide for insurance participants or secondary insurance carriers to share the insurance premiums and risk for the project insurance carrier 1402.

In one embodiment, the project insurance carrier 1402 may offer participation in the insurance assets (e.g., policies, premiums, contract contingencies) to potential insurance participants or carriers 1410a-1410n (collectively 1410). In attempting to find participating insurance carriers 1410, the project insurance carrier 1402 may provide or communicate project information 1412 to the potential participating insurance carriers 1410. The project information may include contract information, contract contingency information, insurance policies, and any other information that the insurance carriers 1410 would like to review prior to agreeing to participate in taking on risk (and receiving associated premiums) with respect to an insurance policy for a project. The potential participating insurance carriers 1410 may submit bids 1414a-1414n (collectively 1414) for an amount of insurance premiums that each would require be paid to accept a certain amount of risk (e.g., 20% of E&O insurance for a project). In this case, the lower the bid, the better chance that an insurance carrier of the potential participating insurance carriers 1410 is likely to win an auction or offer for participating in providing insurance to a project because the lead project insurance carrier 1402 is able to offer the project participants lower premiums for a certain amount of policy risk and the lead project insurance carrier 1402 can charge more for its premiums or keep more of the premiums. In other words, by using an auction process with secondary insurance carriers 1410, the lead project insurance carrier 1402 may lower the overall cost of premiums to the project participants, thereby providing flexibility in pricing premiums.

After the lead project insurance carrier 1402 has selected one or more of the insurance carriers 1410 to participate in an insurance policy, then the lead project insurance carrier 1402 may communicate or otherwise allocate policy percentages 1416a-1416n (collectively 1416) to the respective insurance carriers 1410. It should be understood that one or more of the insurance carriers 1410 may win in an auction, as the lead project insurance carrier 1402 may decide to have one or more secondary insurance carriers 1410 participate in an insurance policy for a project based on size of the policy, complexity of the policy, and any other reason that the lead project insurance carrier 1402 may decide when selecting to have secondary insurance carriers involved in an insurance policy. In addition, the premiums 1408 that are received by the lead project insurance carrier 1402 may be distributed on a percentage basis as premium percentages 1418a-1418n (collectively 1418) to the secondary insurance carriers 1410 that have taken on the insurance policy premiums and risks associated therewith. As understood in the art, in the event that a claim is made against an insurance policy, each of the insurance carriers 1410 owe a percentage of the insurance policy coverage along with the lead project insurance carrier 1402 in order to pay a claim against the insurance policy.

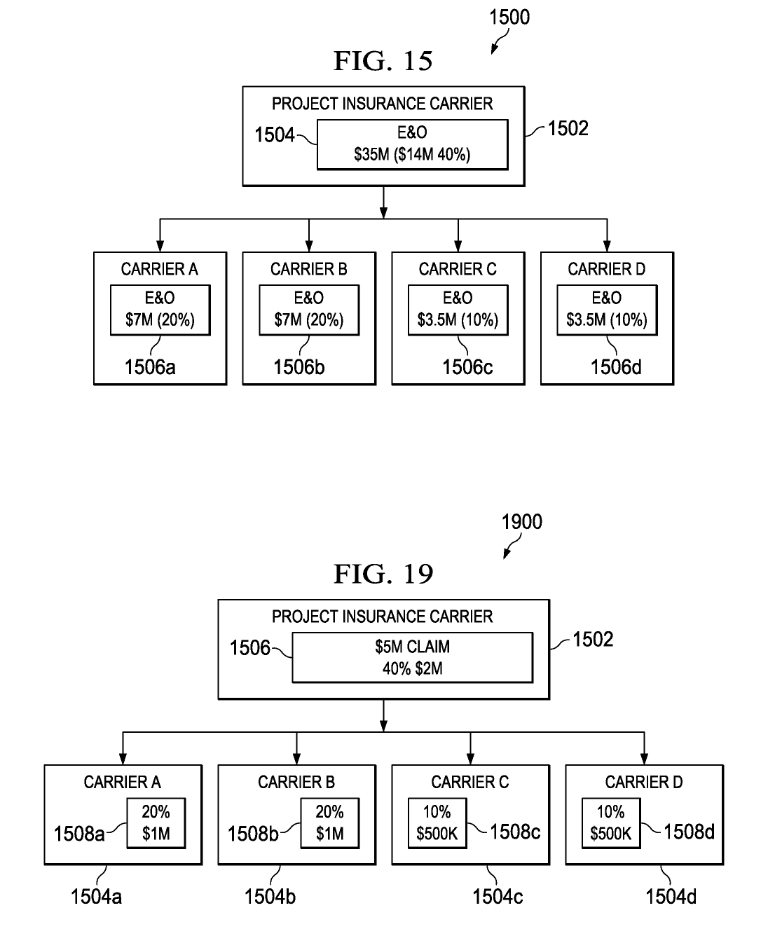

With regard to FIG. 15, a block diagram of an illustrative insurance carrier environment 1500 in which a lead project insurance carrier 1502 that is carrying an insurance policy for project is shown. The insurance policy may include E&O insurance policy 1504 that is part of an overall project insurance policy. As previously described with regard to FIG. 4, an insurance policy for a project may include multiple insurance policies for different categories of insurance. As shown, the E&O insurance policy is for $35,000,000 and the lead project insurance carrier 1502 desires to keep 40% of the insurance policy for a maximum of $14,000,000 of risk. The lead project insurance carrier 1502 may elect to apportion the remaining 60% of the E&O insurance policy 1504 to other insurance carriers A-D. As shown, each of the other insurance carriers A-D has been apportioned 20%, 20%, 10%, and 10%, respectively, of the E&O insurance policy 1504. The ability for the lead project insurance carrier 1502 to apportion a percentage of the E&O insurance policy 1504 helps to reduce overall risk of the lead project insurance carrier and, possibly, to lower premiums for the project participants as the insurance carriers A-D may bid through an auction process resulting in lower premium requirements for taking on the insurance premiums and risk, and the lead project insurance carrier 1502 may select winning bidders based on the lowest bidding prices by the bidding insurance carriers.

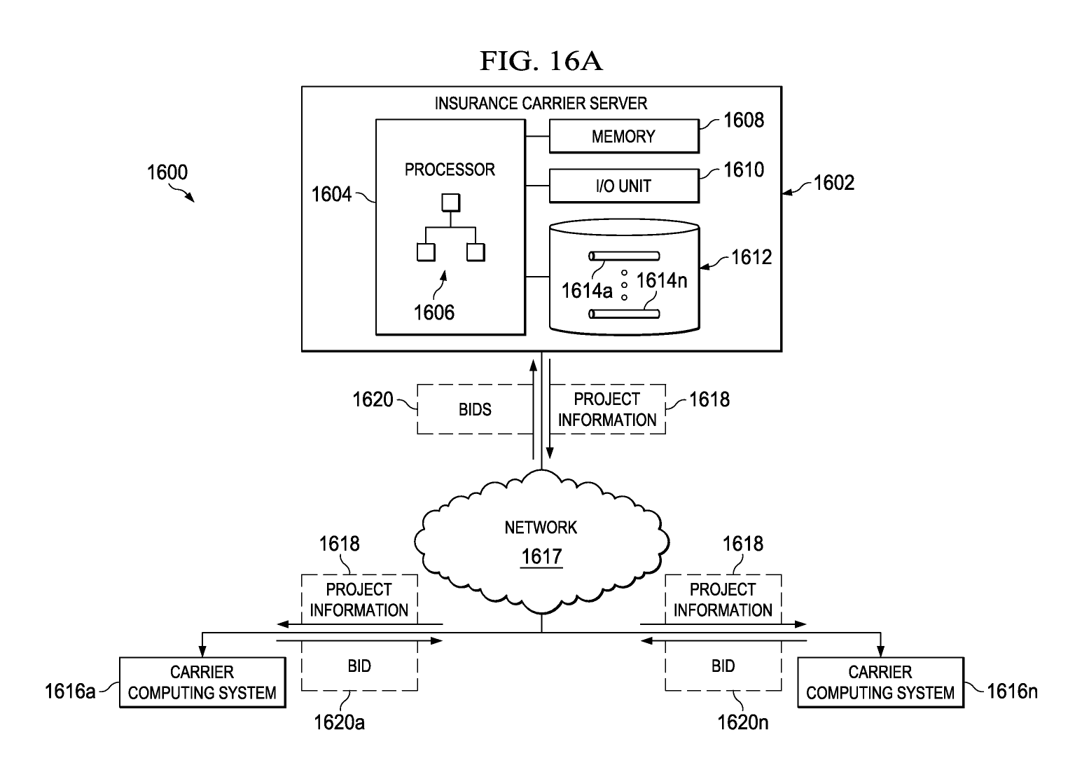

With regard to FIG. 16A, an illustration of an illustrative network environment 1600 is shown, where an insurance carrier is provided with management and communications capabilities to create a secondary market for apportioning insurance policy premiums and risk associated with the insurance policies for a project. An insurance carrier server 1602 may include a processing unit 1604 that executes software 1606. The software may be configured to provide for management of allocation of insurance policies. In one embodiment, the software 1606 may be configured to provide for an auction of percentages of insurance policies, as further described herein. The processing unit 1604 may be in communication with a memory 1608 that is configured to store data and/or software, input/output (I/O) unit 1610 that is configured to communicate externally from the insurance carrier service 1602, and storage unit 1612 that is configured to store data repositories 1614a-1614n (collectively 1614). The data repositories 1614 may be configured to store data associated with insurance policies. The data may include allocation of the insurance policies, information about other carriers who have been apportioned percentages of the insurance policies, and other information that may be used for managing allocation of the insurance policies.

As shown, the insurance carrier server 1602 communicates with carrier computing systems 1616a-1616n (collectively 1616) via a communications network 1617. The communications network 1617 may be the Internet, mobile communications systems, and/or other communications network, as understood in the art. Communications between the insurance carrier server 1602 and carrier computing systems 1616 are illustrative of an auction style offering for other insurance carriers who are operating the carrier computing systems 1616 to participate in the insurance policies being offered by the insurance carrier utilizing the insurance carrier server 1602. It should be understood, however, that non-online auction methods of apportioning insurance policies may be utilized in accordance with the principles of the present invention.

As shown, the insurance carrier server 1602 may communicate project information 1618 to the carrier computing system 1616. In an alternative embodiment, rather than the insurance carrier server 1602 distributing the entirety of the project information 1618, certain portions (e.g., contract terms and documents) of the project information 1618 may be delivered by another computing system, such as the management server 302 (FIG. 3) that is accessible via the network 1617 by the carrier computing systems 1616. The carriers that receive the project information 1618 may have the ability to review details of a project, including contractual terms, contract contingencies, insurance terms, and any other information that is established for managing a project and insuring the project. If the other carriers considering taking on the insurance policy premiums and risks decide to participate, then the insurance carriers may submit bids 1620a-1620n (collectively 1620) from the carrier computing system 1616, respectively, to the insurance carrier server 1602. The insurance carrier server 1602 may store the bids in association with the project information, whether or not the project information is a complete set of project information or an abbreviated set of project information.

The insurance carrier operating the insurance carrier server 1602 may thereafter review the bids from the other carriers to determine which bids are the lowest and/or which bids are most acceptable (e.g., not the lowest, but possibly the safest for the insurance carrier), and award the insurance carrier(s) with participation of an insurance policy. Although not shown, after the insurance carrier has apportioned insurance policies to the secondary insurance carriers, the insurance carrier server 1602 may communicate claim submissions and information throughout a claim process by a project participant to notify the insurance carriers operating the carrier computing systems 1616 that claims have been made on the insurance policies to which the insurance carriers have risk. Additionally, but not shown, the insurance carrier server 1602 may send statements of premium payments to the carrier computing systems 1616 to notify the secondary carriers of insurance premiums that are being paid for their respective insurance policies. It may be considered that the insurance carrier server 1602 may be used to create a secondary market for the insurance policy participation of secondary insurance carriers. In one embodiment, the participation in the insurance policies may be traded or otherwise sold to authorized insurance carriers by the project insurance carrier(s) or lead insurance carrier(s).

With regard to FIG. 16B, a block diagram of an illustrative set of software modules 1622 that may be used to manage project insurance policies is shown. The modules 1622 may include a distribute project information module 1624 that is configured to distribute project information. The project information may include any information associated with the project that an insurance carrier would consider to be material in making a decision as to the amount of premiums to charge for a certain amount of insurance coverage. For example, the project information may include project participant information, project location, nature of project, contract terms, contract contingency, insurance information, and so forth. The module 1624 may be configured to communicate the project information in response to an insurance carrier logging into a system of a project insurance carrier. In one embodiment, the module 1624 may operate on the project insurance carrier system. Alternatively, the module 1624 may be configured to operate on a management server of a project participant or third-party provider that hosts a project. The module 1624 may be configured to provide access to the project information that may be stored by the management server (FIG. 3A). The module 1624 may further be configured to communicate insurance information associated with an insurance policy or multiple insurance policies being offered for apportionment by the project insurance carrier.

A receive bid/offer submissions module 1626 may be configured to receive a bid or offer from a potential insurance carrier interested in participating in one or more insurance policies. The module 1626 may be configured to receive a bid or offer and store the bid or offer in association with an insurance policy associated with the project. It should be understood that (i) a bid may be received if the insurance carrier is operating an auction or (ii) an offer if the insurance carrier is simply accepting an offer from another insurance carrier that is not part of an auction. If an auction is being operated, the module 1626 may be configured to set a time limit by which other insurance carriers are to submit their bids.

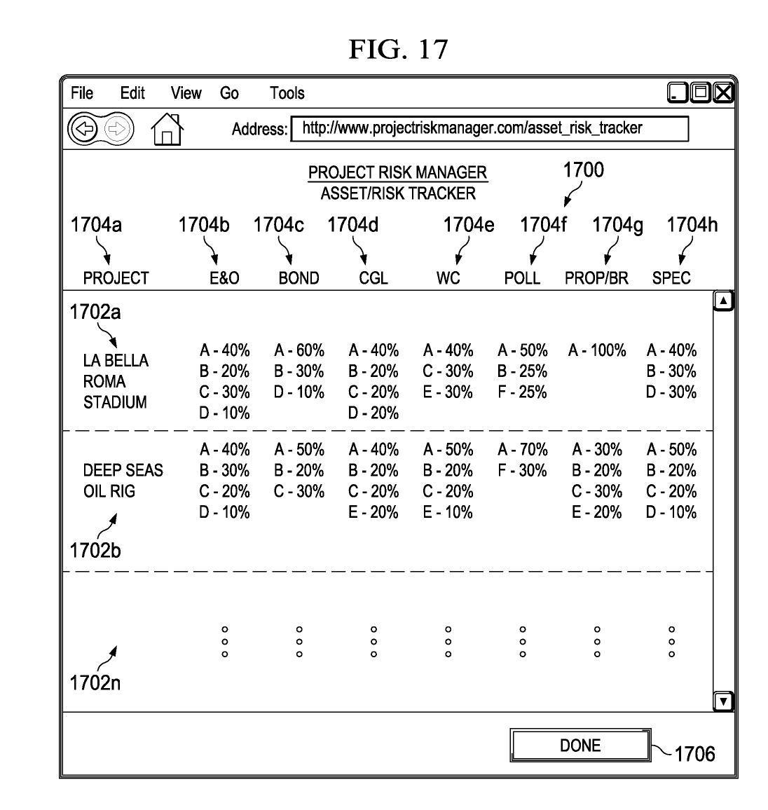

An auction bid selector module 1628 may be configured to display a listing of bids and enable the lead project insurance carrier to select carrier(s) that are to receive an award. In one embodiment, the module 1628 may be configured to list the bids in ascending order. The module 1628 may be configured to display the bids on a GUI, such as the GUI shown in FIG. 18, and allow the lead project insurance carrier to list the percentages in association with each of the bidding or offering insurance carriers.

An asset/risk tracker module 1630 may be configured to display a GUI with a list of each of the insurance carriers associated with each of in the insurance policies for one or more projects. It should be understood that a wide variety of information may be included on one or more GUIs by the module 1630, such as current balances for each of the insurance policies.

A premium calculator module 1632 may be configured to access the bids or awards and calculate a total premium to be presented to the project participants by the lead project insurance company. As an example, a summation may be used to compute a total premium, monthly or otherwise, by using the premium values that the lead project insurance carrier and each of the insurance carriers that were selected for apportionment of the insurance policies submitted. For example, if the lead project insurance carrier elected to charge $250,000 for 40% of a $60,000,000 policy and three other insurance carriers submitted to charge $100,000, $125,000, and $150,000, respectively, for 20% of the $60,000,000 policy, then the summation results in $625,000 per month in insurance premiums for the duration of the project development. The calculated premium may be presented to the project participants.

A claim tracker module 1634 may be configured to track claims that are submitted during the project development. In addition to tracking claims, the module 1634 may be configured to track responses, decisions, appeals, and appeal decisions, so that the insurance carrier(s) may be notified of possible insurance payouts that may occur in relation to the project. The module 1634 may be configured to send a notification to the insurance carrier(s) that have been apportioned an insurance policy for a project.

A claim payment calculator module 1636 may be configured to calculate claim payments due by each of the insurance carriers that have been apportioned a portion of an insurance policy for a project. In one embodiment, the insurance policy may include a contract contingency, which may be a percentage of a total insurance policy. The insurance carrier(s) may be paid on the contract contingency up-front or through premium payments, as understood in the art. The insurance carrier(s) may manage the contract contingencies in the same or similar manner as the insurance policies, but allow for a project manager to have access to the contract contingencies, as provided by a project contract. In response to a claim against either a contract contingency or insurance policy, a calculation may be made to determine how much each insurance carrier owes for risk apportioned to the respective insurance carrier.

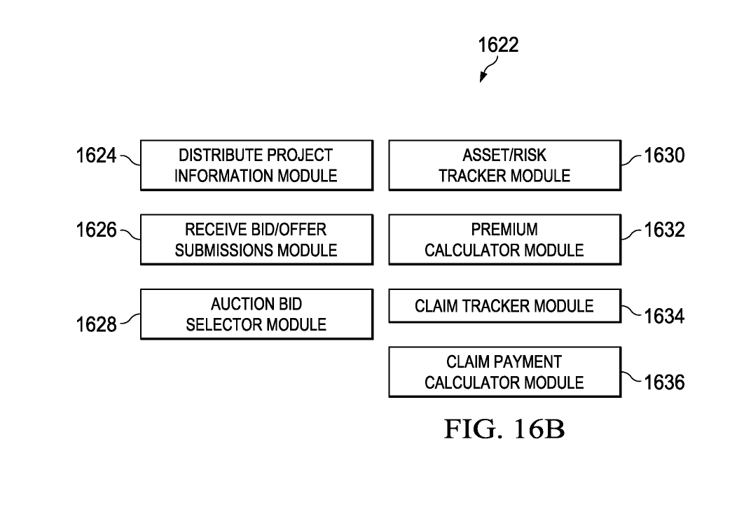

With regard to FIG. 17, a screenshot of an illustrative asset/risk tracker listing 1700 is shown. As shown, there are a number of project listings, including La Bella Roma stadium project listing 1702a, Deep Seas Oil Rig listing 1702b, and other listings 1702n. Each of the listings may include a number of data fields associated with each of the listings. The listing may include listing project name 1704a, E&O holders and equity percentages 1704b, bond holders and equity percentages 1704c, CGL policy holders and equity positions 1704d, workers compensation policies holders and equity positions 1704e, pollution liability policy holders and equity positions 1704f, property/builder's risk policy holders and equity positions 1704g, and specialty policies holders and equity positions 1704h. As shown, the insurance companies are listed as A, B, C, D, E, and F. The lead insurance carrier that writes the insurance policies with each of the projects 1704a is shown as insurance carrier A. As further shown, each of the different polices 1704b-1704h may be held by one or more insurance carriers A-F. It should be understood that rather than using letters (e.g., “A”) for the names of the insurance carriers, the actual names of the insurance carriers may be listed. It should also be understood that alternative arrangements of the information may be shown, such as having the percentages be listed in different data fields. In one embodiment, the names of the insurance carriers and percentages of ownership (or liability/risk) may be listed in a separate field or accessible in response to a user selecting one of the projects 1702a, for example. Once the user has completed his or her review of the asset/risk tracker page 1700, the user may select a “done” soft-button 1706.

With regard to FIG. 18, a screen shot of an illustrative auction bid selector GUI 1800 is shown to include a project bid submissions section and an awards entry section for each of the different insurance policies being utilized for the project. In one embodiment, to normalize the bids with respect to one another, a bid per 10%, for example, of the asset/risk may be shown for each of the bidders, as shown by a listing 1802 with each of the insurance carrier bidders. The lead insurance company that writes the insurance policy for the project may review each of the submitted bids and select to award the bids based on having the least amount required for premiums, being a stable insurance carrier, or for any other reason. In response to selecting secondary insurance carriers to award the assets/risk, the lead insurance carrier may enter percentages into an awards section 1804 with text entry fields, for example, associated with each of the insurance carrier bidders. In one embodiment, the auction bid selector may be automated to select the lowest bid, lowest two bids, or lowest three bids, depending upon the number of insurance participants desired by the lead project insurance carrier. In an alternative embodiment, an algorithm may be utilized to select bidders based on a total premium per percentage point desired by the lead project insurance carrier. In yet an alternative embodiment, the auction bid selector may be manual. It should be understood that a wide variety of graphical user interface elements may be utilized to enter and/or select bidders and amounts to award each of the selected bidders.

Upon completion of selection for each of the bidders for each of the different insurance policies (e.g., E&O, bond, CGL, etc.), the user may select a “submit” soft-button 1806 to submit the winning bidders and associated awards to the bidders. It should also be understood that rather than using a bidding system, a non-bidding system that allows a lead insurance carrier who writes an insurance policy or coordinated set of insurance policies for a project may be utilized. In response to the user submitting the awards, the system may automatically update a data repository to store the secondary carriers and percentages associated with those carriers so that those carriers may thereafter be appropriately paid insurance premiums and notified and charged insurance payouts in the event of a claim against the insurance policies.

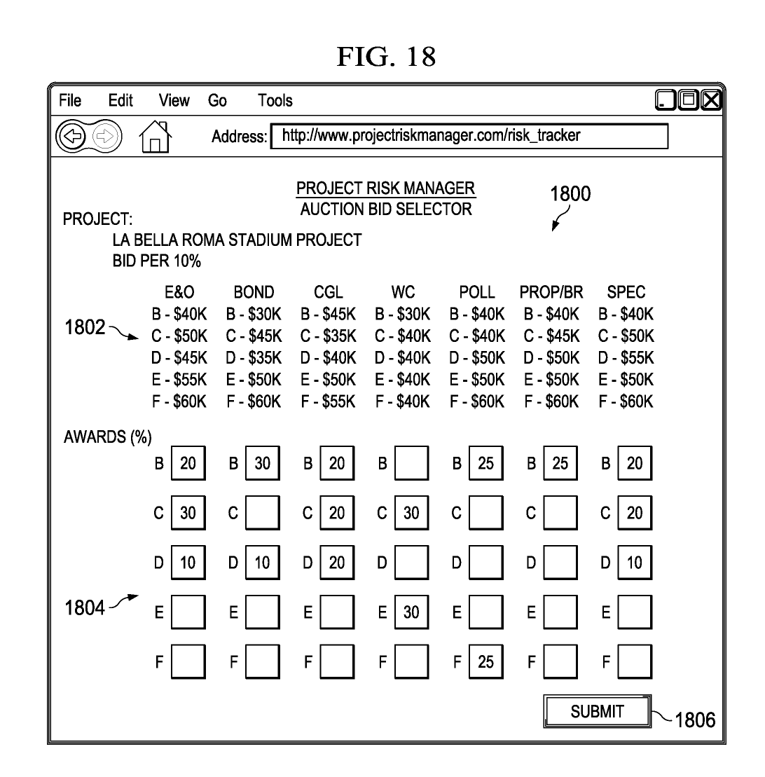

With regard to FIG. 19, a block diagram of an illustrative insurance carrier relationship 1900 for a lead project insurance carrier 1502 and secondary insurance carriers 1504a-1504d is shown. As shown, the lead project insurance carrier 1502 has received a $5 million claim 1506 against a policy, such as an E&O insurance policy, for a particular project. In this case, the lead project insurance carrier 1502 holds a 40 percent interest in the insurance policy with a risk of $2 million to pay the $5 million claim. In this case, the lead project insurance carrier 1502 has allocated 60 percent of the risk to carriers A-D, where carrier A has allocated risks 1508a-1508d to each of the respective carriers. As shown, carrier A has 20 percent of the risk or $1 million of exposure for the $5 million claim 1506, carrier B has 20 percent of the exposure or $1 million dollars for the $5 million claim 1506, carrier C has 10 percent exposure or $500,000 of the $5 million claim 1506, and carrier D has 10 percent or $500,000 of exposure for the $5 million claim 1506. In one embodiment, the lead project insurance carrier 1502 may pay the entire balance and collect the remaining balance from each of the carriers. Alternatively, each of the carriers 1504a-1504d may be required to pay its share of the risk to the lead project insurance carrier 1502 or, alternatively, directly to the project owner or claimant based on each carrier's respective percentage.

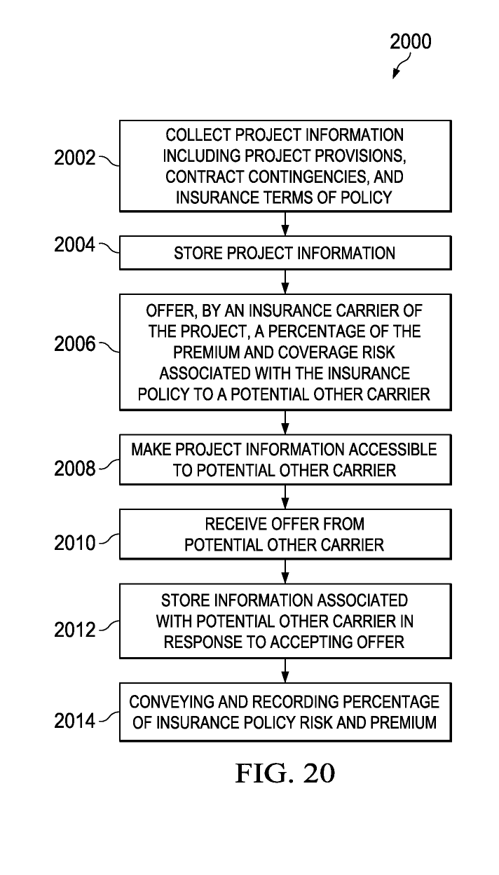

With regard to FIG. 20, a flow diagram of an illustrative process 2000 for apportioning premiums and risks of insurance policies from a lead insurance carrier for a project to other insurance carriers is shown. The process 2000 starts at 2002, where project information including project provisions, contract contingencies, and insurance terms of an insurance policy may be collected. In one embodiment, the collection may be performed by a lead insurance carrier. It should be understood that the project information does not need to be a full set of project information, but rather any information that is associated with a project being insured by the lead insurance carrier. At step 2004, the project information may be stored. In one embodiment, the project information may be stored on a data repository by the lead insurance company. In an alternative embodiment, the project information may be stored by a third-party, but be accessible to the lead insurance carrier or any other insurance carrier considering being part of an insurance policy review process for submitting a bid to take on some level of ownership of the policy and risk associated with the policy.

At step 2006, a lead insurance carrier for the project may offer a percentage of the premium and coverage risk associated with the insurance policy to a potential other insurance carrier. The offer may be performed by hosting a website that allows for other insurance carriers to review the project information and, in one embodiment, bid on becoming an insurance carrier along with the lead insurance carrier that has or is in the process of insuring a project. In one embodiment, the offer may be performed prior to the lead project insurance carrier actually insuring the project to enable the lead project insurance carrier to determine how much premiums will cost the project participants. In another embodiment, the offer may be performed after the insurance policy has been written and accepted by the project participants so that the lead project insurance carrier may offset or otherwise apportion some of the risk to another insurance carrier. At step 2008, the project information may be made accessible to the potential other carrier. It should be understood that offers may be made before and after creation of the insurance policies. Making the project information accessible may mean to simply provide project information, such as via a website over the Internet, email, or otherwise allow the potential other carrier to review the project, such as contractual terms, contractual contingencies, and insurance terms.

At step 2010, an offer may be received from the potential other carrier, where the offer may be an offer to accept a certain amount of premiums for the other carrier to accept carrying the insurance policy along with risks associated with the insurance policy. In one embodiment, the offer may be made as a bid in an auction. At step 2012, information associated with the potential other carrier may be stored in response to accepting the offer. From one embodiment, the information may be the name of the carrier, the address of the carrier, amount of percentage of the insurance policy that is being apportioned to the other carrier, and so forth. At step 2014, a percentage of the insurance policy risk and premium may be conveyed and recorded. In conveying and recording the percentage of insurance policy risk and premium, the lead project insurance carrier may store that information in a data repository in association with the policy written on the project, and issue (e.g., print and mail, email, or otherwise file with a government entity) to ensure that the other or secondary insurance carrier has proof of being an insurance carrier on the project along with the lead project insurance carrier.

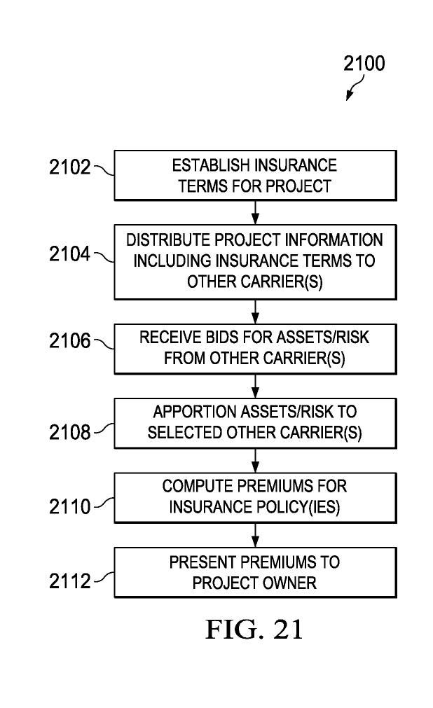

With regard to FIG. 21, a flow diagram of an illustrative process 2100 for conducting an auction for participation in premiums and risks for the insurance policies on a project is shown. The process may start at step 2102, where insurance terms for the project may be established. In establishing the insurance terms, the lead insurance company or project insurance company may create an insurance policy for a project with project participants and store the insurance terms in a data repository, for example. At step 2104, the project information including the insurance terms may be distributed to one or more other carriers. In distributing the project information, the other carriers may have the ability to access the project information so as to be able to determine whether or not to participate in the insurance policy.

At step 2106, bids for assets/risk from the other carrier(s) may be received. The bids may be received via an electronic communication, such as a submission into a web page, email, or any other communication, such as a letter or phone call, to allow the lead project insurance carrier to enter the bid into a computing system, such as by a computing system hosting the GUI shown in FIG. 18. The bids received from the other carriers may be stored by a computing system to allow the lead project insurance carrier to review each of the bids and select automatically, manually, or semi-automatically, winners of the bidding process and allocate a certain percentage of an insurance policy that is insuring at least a portion of a project (e.g., E&O insurance policy of a project).

At step 2108, assets/risk may be apportioned to the selected other carrier(s). In apportioning the assets/risk to the selected other carriers, a percentage of an insurance policy may be entered into a computing system or the computing system may automatically select what percentage to assign to the other carrier(s). At step 2110, premiums for an insurance policy or policies may be computed. In one embodiment, the premiums may be made based on bids that were submitted for secondary insurance carriers to accept a certain premium for carrying a certain amount of risk associated with the insurance policy. The computation may be made by adding each of the bids, along with the lead project insurance carrier's premium requirements, to carry a certain amount of risk. For example, if a lead project insurance carrier is offering $30 million of E&O insurance to a project, then the computation may include adding up how much premiums each of the insurance carriers is willing to take for its respective percentage of the risk (e.g., carrier A will accept $150,000 for 40 percent, carrier B will accept $120,000 for 30 percent of the policy, carrier C will accept $50,000 for 10 percent of the policy, and carrier D will accept $75,000 for 20 percent of the policy).

At step 2112, a presentation of the computed premiums may be made to the project participants. That is, the total premiums from the lead project insurance carrier and secondary insurance carriers may be added up and presented to the project participants to consider in selecting the project insurance carriers to insure the project.

The previous description is of a preferred embodiment for implementing the invention, and the scope of the invention should not necessarily be limited by this description. The scope of the present invention is instead defined by the following claims.

I claim:

1. A method for managing risk on a project, said method comprising:
storing, by a computing system, project information that defines scope, schedule, and contractual obligations for the project being covered, so as to reflect contract risk allocation provisions and project contingencies as specified in contract provisions for the project, the project further being insured by a coordinated set of insurance policies, the project information further including project definitions and terms of the insurance policies;
enabling a project participant to submit a claim to the computing system for coverage under the project contingencies or insurance policies that is related to at least one project definition;
enabling at least one other project participant to submit a response to the submitted claim to the computing system;
providing, by the computing system, access to the submitted claim and to at least one submitted response to a project manager;
enabling the project manager to submit a decision to the computing system about the submitted claim; and
notifying, by the computing system, the project participants of the decision about the submitted claim by the project manager.

2. The method according to claim 1, further comprising:
establishing a time limit for the project manager to submit the decision; and
notifying the project manager of a specific time by which the decision of the claim is due based on a time of submission of the claim and the established time limit.

3. The method according to claim 2, further comprising sending the project manager a notice of the submitted claim and the at least one submitted response.

4. The method according to claim 1, further comprising sending the at least one other project participant notice of the submitted claim.

5. The method according to claim 1, further comprising:
enabling the project participant and the at least one other project participant to submit an appeal in response to the decision about the submitted claim by the project manager; and
in response to receiving a submitted appeal, notifying an appeals decider of the submitted appeal.

6. The method according to claim 5, further comprising:
receiving, by the computing system, a decision of the appeals decider of the submitted appeal; and
notifying the project participant and the at least one other project participant of the decision of the appeals decider.

7. The method according to claim 6, further comprising:
notifying, by the computing system, the project participants of the decision of the appeals decider; and
enabling the project manager to finalize a decision and allocation for the claim.

8. The method according to claim 7, further comprising:
displaying the available balances in the contract contingencies and insurance policies to the project participants; and
enabling the project manager to allocate from the contract contingencies and insurance policies based on claim decision; and
maintaining an accurate and current accounting of the contract contingencies, insurance policies, claims, decisions and related allocations.

9. The method according to claim 5, further comprising:
establishing a time limit for the appeals decider to submit a decision of the appeal; and
notifying the appeals decider of a specific time by which the decision of the appeal is due based on a time of submission of the appeal and the established time limit.

10. The method according to claim 5, wherein the project information further includes identifications of the project manager and an appeals decider, and wherein decisions of the appeals decider are binding on the project participants.

11. The method according to claim 1, further comprising:
defining the contract contingencies and insurance policies based on the contract provisions, terms of the insurance policies, and the categories of problems for which the contract contingencies and insurance policies provide coverage and funds;
allocating a balance for each of the categories of the contract contingencies and insurance policies;
recording and accounting for the amounts in each of the categories of the contract contingencies and insurance policies based on submitted claims, decisions and related allocations; and
in response to claims determined to be valid by the project manager or appeals decider, adjusting the available balance of the determined category of the contract contingencies or insurance policies.

12. The method according to claim 1, further comprising providing, by the computing system, a user interface that enables the project manager with the ability to set payment, disbursement, and allocation of the project contingencies or insurance policies.

13. The method according to claim 1, further comprising:
receiving a third-party claim from any of the project participants;
presenting the third-party claim to the project manager;
receiving a determination from the project manager as to whether the third-party claim is to be covered by any of the categories of the contract contingencies and insurance policies;
receiving an indication as to which category of the categories of the contract contingencies and insurance policies the third-party claim is to be allocated; and
in response to the third-party claim being determined to be covered by the project manager, adjusting the available balance of the indicated category of the categories of the contract contingencies and insurance policies.

14. A system for managing risk on a project, said system comprising:
a storage unit configured to store project information that defines scope, schedule, and contractual obligations for the project being covered, so as to reflect contract risk allocation provisions and project contingencies as specified in contract provisions for the project, the project further being insured by a coordinated set of insurance policies, the project information further including project definitions and terms of the insurance policies;
a processing unit in communication with said storage unit, and configured to:
enable a project participant to submit a claim to the computing system for coverage under the project contingencies or insurance policies that is related to at least one project definition;
enable at least one other project participant to submit a response to the submitted claim;
provide access to the submitted claim and to at least one submitted response to a project manager;
enable the project manager to submit a decision about the submitted claim; and
notify the project participants of the decision about the submitted claim by the project manager.

15. The system according to claim 14, further comprising an input/output unit in communication with said processing unit, and
wherein said processing unit is further configured to:
establish a time limit for the project manager to submit the decision; and
notify the project manager of a specific time by which the decision of the claim is due based on a time of submission of the claim and the established time limit.

16. The system according to claim 15, wherein said processing unit is further configured to send the project manager a notice of the submitted claim and the at least one submitted response.

17. The system according to claim 14, wherein said processing unit is further configured to send the at least one other project participant notice of the submitted claim.

18. The system according to claim 14, wherein said processing unit is further configured to:
enable the project participant and the at least one other project participant to submit an appeal in response to the decision about the submitted claim by the project manager; and
in response to receiving a submitted appeal, notify an appeals decider of the submitted appeal.

19. The system according to claim 18, wherein said processing unit is further configured to:
receive a decision of the appeals decider of the submitted appeal; and
notify the project participant and the at least one other project participant of the decision of the appeals decider.

20. The system according to claim 18, wherein said processing unit is further configured to:
notify the project participants of the decision of the appeals decider; and
enable the project manager to finalize a decision and allocation for the claim.

21. The system according to claim 20, wherein said processing unit is further configured to:
display the available balances in the contract contingencies and insurance policies to the project participants; and
enable the project manager to allocate from the contract contingencies and insurance policies based on claim decision; and
maintain an accurate and current accounting of the contract contingencies, insurance policies, claims, decisions and related allocations.

22. The system according to claim 18, further comprising:
establishing a time limit for the appeals decider to submit a decision of the appeal; and
notifying the appeals decider of a specific time by which the decision of the appeal is due based on a time of submission of the appeal and the established time limit.

23. The method according to claim 18, wherein the project information further includes identifications of the project manager and an appeals decider, and wherein decisions of the appeals decider are binding on the project participants.

24. The system according to claim 14, wherein said processing unit is further configured to:
define the contract contingencies and insurance policies based on the contract provisions, terms of the insurance policies, and the categories of problems for which the contract contingencies and insurance policies provide coverage and funds;
allocate a balance for each of the categories of the contract contingencies and insurance policies;
record and account for the amounts in each of the categories of the contract contingencies and insurance policies based on submitted claims, decisions and related allocations; and
in response to claims determined to be valid by the project manager or appeals decider, adjust the available balance of the determined category of the contract contingencies or insurance policies.

25. The system according to claim 1, wherein said processing unit is further configured to provide a user interface that enables the project manager with the ability to set payment, disbursement, and allocation of the project contingencies or insurance policies.

26. The system according to claim 1, wherein said processing unit is further configured to:
receive a third-party claim from any of the project participants;
present the third-party claim to the project manager;
receive a determination from the project manager as to whether the third-party claim is to be covered by any of the categories of the contract contingencies and insurance policies;
receive an indication as to which category of the categories of the contract contingencies and insurance policies the third-party claim is to be allocated; and
in response to the third-party claim being determined to be covered by the project manager, adjust the available balance of the indicated category of the categories of the contract contingencies and insurance policies.
